(19) United States
(12) Patent Application Publication
(10) Pub. No.: US 2017/0276160 A1
(43) Pub. Date: Sep. 28, 2017

(54) STRUCTURAL ASSEMBLY AND METHOD

(71) Applicant: Changize SADR, Toronto (CA)

(72) Inventor: Changize SADR, Toronto (CA)

(21) Appl. No.: 15/303,697

(22) PCT Filed: Apr. 15, 2015
(86) PCT No.: PCT/CA2015/000246

§ 371 Date: Nov. 22, 2016

Related U.S. Application Data
(60) Provisional application No. 61/979,702, filed on Apr. 15, 2014.

(51) Int. Cl. F16B 17/00; B29C 70/08; F16L 9/17; B29C 70/84; F16B 5/01; F16B 11/00

(52) U.S. Cl. CPC F16B 17/008; F16B 5/01; F16B 11/006; F16L 9/17; B29C 70/84; B29C 70/088; B29L 2023/22

(57) ABSTRACT

A structural assembly includes a first member defining a matrix material, and a second member defining a skin. The skin has a roughed surface of hooks or barbs. The second member is engaged to the first member to define a mechanically interlocked assembly. The assembly may include an open-cell matrix material in a glue-less connection. The assembly may include a chemical bond in addition to a mechanical bond. The assembly may include internal layers of pre-impregnated composite fiber and resin. The skin member may act as a jig for a green composite member. The skin member may be deformed in a press to present a non-planar surface for such other members as may be attached to it. Assemblies may be formed with mechanical interconnection in place of glue or adhesive connections. Assemblies may be formed to may light, thin-walled pipe, flasks, pressure vessels and so forth.

This application claims the benefit of priority of U.S. Provisional Patent Application 61/979,702 filed Apr. 15, 2014, the specification and drawings thereof being incorporated by reference herein in their entirety.

### FIELD OF INVENTION

This description relates to structures of mechanically connected materials and methods of manufacture pertaining to those structures.

### BACKGROUND OF THE INVENTION

The joining of similar or dis-similar materials may involve dis-similar metals, dis-similar polymers, or dis-similar lignocellulosic materials, or a combination of those groups. In manufacturing it is sometimes difficult to bond dis-similar materials effectively, or there may be instances where it is desired to join similar materials but without glues, adhesives, bonding agents, curing, welding, or chemical reaction processes. It may also involve adhesive bonding welding, or gluing processes that may have significant curing times, or that may involve the off-gassing of chemicals that present a disposal challenge. The ability to bond dis-similar materials by mechanical inter-connection as either a replacement for a chemical or thermal curing process, or as a preliminary step to a curing process, may present opportunities for improvement of manufacturing.

### SUMMARY OF INVENTION

The following summary may introduce the reader to the more detailed discussion to follow. The summary is not intended to, and does not, limit or define the claims.

In an aspect of the invention there is an assembly of materials. The assembly includes a first member and a second member. The second member has an array of mechanical interlock members. The first member is made of a first material. The second member is made of a second material. The first material is less hard than the second material. The first member has a through thickness. The second member has a through thickness less than the through thickness of the first member. The mechanical interlock members of the array are mechanically embedded in the first member, and, when so embedded, the first and second members define a substantially rigid body resistant to bending.

In a feature of that aspect of the invention, the second member defines a protective skin of the assembly. In another feature, the second material is different from the first material. In a feature of that aspect of the invention, the first member has a length, a width, and the through thickness. The second member a length, a width, and the through thickness. At least one of (a) the width of the second member is smaller than the width of the first member; and (b) the length of the second member is less than the width of the first member. In another feature, the second member has a continuous web from which the mechanical interlock members stand outwardly into the first member, and the web of the second member defines a skin less than 1/10 of the through thickness of the first member. In another feature, the second member has an exterior final finish. In a further feature, the second member defines a wear surface of the assembly. In a yet further feature, the first member is made of a material that is one of a polymer, aluminum, an aluminum alloy, copper, and mild steel; and the second member is made of aluminum, copper, bronze, brass, nickel, alloys or nickel, chromium, alloys of chromium, steel, stainless steel, and titanium. In a still further feature, the assembly includes a pairing that is one of: (a) the first member is a polymer, the second member is any of the aforesaid metals; and (b) the first member is one of aluminum, aluminum alloy, copper, bronze and brass; the second member is one of steel, stainless steel, and titanium.

In another feature, the first member is at least partially of hollow section. In another feature, the partially hollow section is at least in part a closed periphery hollow section. In a further feature, the first member is an extrusion. In another feature, the second member is roll-formed to conform to at least a portion of the first member. In a further feature, the first member is an extrusion and the second member is roll formed to the extrusion. The extrusion has a direction of extrusion, and the second member has a roll-forming direction that is parallel to the direction of extrusion. In another feature, the assembly is a foot support and the second member has an exposed surface defining a tread surface of the foot support. In a further feature, the assembly is an exterior body panel of an automobile, and the second member defines a trim member of the assembly. In an alternate feature, the assembly defines a portion of one of (a) a window frame; and (b) a door frame.

In another feature, when viewed along an axis of projection the first member has a projected area; when viewed along the axis of projection the second member has a smaller projected area than the first member; the second member is at least partially non-planar. In another feature, the second member is of non-cylindrical section. In another feature, the second member has a direction of embedment of the mechanical interlock members that is coincident with the axis of projection.

In a further feature of that aspect or of any of the preceding features, the mechanical interlock members are any of hooks, or prongs, or barbs, however they may be called. In a further feature, the first member includes an array of cells in which at least some cell walls are oriented to stand predominantly away from the second member. In a further feature, the cells of the array are substantially hexagonal when viewed normal to the second member. In an alternate feature, the cells of the array are substantially rectangular when viewed normal to the second member. In another feature, the assembly includes a third member; the first member lies between the first member and the second member; the first member when mounted to the second member functions as a first flange; the third member when mounted to the second member functions as a second flange spaced away from the first flange.

In another feature, the third member is made of a different material than the first member. In still another feature, the first member is a metal and the third member is a polymer. In still another feature, a fibrous member is captured between the first member and the second member, and the mechanical interlock members of the array of the first member reach through the fibrous member to engage the second member. In still yet another feature, the fibrous member includes a woven fibrous member. In a further feature, the woven fibrous member includes strands of composite reinforcement fibers. In another feature, the woven fibrous member includes strands of composite resin. In another feature, the fibrous member is uncured. In a subsequent feature, the fibrous member and its resins are cured after mechanical inter-connection.

In another aspect there is an assembly of materials that includes a first member that is made of a first material being less hard than the second material. The first member has a through thickness. The second member has an array of mechanical interlock members and is made of a second material. The second member has a web having a through thickness less than the through thickness of first member. The mechanical interlock members of the array are mechanically embedded in the first member, and, when so embedded, the first and second members define a substantially rigid body resistant to bending, e.g., out-of-plane bending. The web of the second member defines a skin of the assembly.

In another feature, the first member has a length, a width, and a through thickness. The and said second member a length, a width, and said through thickness; and at least one of (a) said width of said second member being smaller than said width of said first member; and (b) said length of said second member being less than said width of said first member.

In another feature, the assembly of the second member has a continuous web from which said mechanical interlock members stand outwardly into the first member, and the web of the second member defines a skin less than 1/10 of the through thickness of the first member. The assembly of the second member has an exterior final finish wherein the second member defines a wear surface of the assembly.

In another feature, the assembly of the first member is made of a material that is one of a polymer; aluminum, an aluminum alloy, copper, and mild steel and the second member is made of aluminum, copper, bronze, brass, nickel, alloys or nickel, chromium, alloys of chromium, steel, stainless steel, and titanium. In another feature, the assembly includes a pairing that is one of: (a) first member is a polymer and second member is any metal; and (b) first member is one of aluminum, al alloy, copper, bronze and brass and second member is one of steel, stainless steel, and titanium.

In another feature, the assembly of the first member is at least partially of hollow section wherein said partially hollow section is at least in part a closed periphery hollow section. In another feature, the assembly of the first member is an extrusion wherein the second member is roll-formed to conform to at least a portion of said first member. In another feature, the assembly of the first member is an extrusion. The extrusion having a direction of extrusion. The second member is roll formed to the extrusion. The second member having a roll-forming direction that is parallel to the direction of extrusion.

In another feature, the assembly is a foot support and the second member has an exposed surface defining a tread surface of the foot support. In another feature, the assembly is an exterior body panel of an automobile, and the second member defines a trim member of the assembly. In another feature, the assembly defines a portion of one of (a) a window frame: and (b) a door frame. In another feature, the assembly wherein when viewed along an axis of projection the first member has a projected area; when viewed along the axis of projection the second member has a smaller projected area than the first member; said second member is at least partially non-planar. The assembly wherein the second member is of non-cylindrical section.

In a further feature, the second member has a direction of embedment of the mechanical interlock members that is coincident with the axis of projection. The mechanical interlock members are hooks.

In another feature, the first member includes an array of cells in which at least some cell walls are oriented to stand predominantly away from the second member. The cells of the array are substantially hexagonal when viewed normal to the second member. The cells of the array are substantially rectangular when viewed normal to said second member. In another feature, the assembly includes a third member. The first member lies between the first member and the second member. The first member when mounted to the second member functions as a first flange. The third member when mounted to the second member functions as a second flange spaced away from the first flange. In another feature, the third member is made of a different material than the first member. The first member is a metal and the third member is a polymer.

In another feature, a fibrous member is captured between the first member and the second member, and the mechanical interlock members of the array of the first member reach through the fibrous member to engage the second member. In a further feature, the fibrous member includes a woven fibrous member. In still another feature, the woven fibrous member includes strands of composite reinforcement fibers. In another feature, the woven fibrous member includes strands of composite resin. In still another feature the fibrous member is uncured.

In another aspect of the invention there is a mechanical interlock assembly. It has a first member and a second member. The first member has a web. The web has a first face having an array of mechanical interface members formed thereon of the material of the first member. The web has a self-holding non-planar form. The second member is a cloth member. The cloth member is engaged with the array of mechanical interface members of the first member. The first member thereby defines a non-planar shape-forming jig for the cloth member.

In another feature, the cloth member has been cured, and the first and second members form a rigid, mechanically interlocked structural member. In another feature, the mechanical interlock assembly includes a third member, and the cloth member is located between the first member and the third member. In another feature, the mechanical interface members of the first member reach through the second member to engage the third member. In still another feature, the third member is an open-celled web array. In a still further feature, the first member defines a first flange of the assembly, the assembly includes a second flange distant from the first flange, and the second member is located between the first and second flanges. In a further feature, the first member is made of metal.

In another aspect of the invention there is a method of manufacture of a non-planar assembly. The method includes obtaining a feedstock of web material. At least a portion of the web material defines a first member. The web material has at least one surface having an array of hooks formed therein from the web material itself. The method includes plastically deforming the first member to a self-sustaining non-planar condition; and engaging a second member to the array of hooks after the first member has been plastically deformed, whereby the second member takes on the non-planar condition of the first member.

In a feature of that aspect of the invention, the method includes adding a third member, the second member being between the web member and the third member. In another feature, the second member is a cloth material and the method includes engaging the cloth material to the array of hooks whereby the cloth material conforms to the non-planar condition of the plastically deformed web material. In a further feature, the method includes mechanically interconnecting an expanded cell web to the first member. In a further feature, the first member defines an outer wall, and the method includes one of (a) having and (b) forming, an inner wall, the expanded cell web being located between the inner wall and the outer wall.

In another feature, the first member is plastically deformed to have the shape of one of (a) an end cap; and (b) an outlet, of a flask. The method includes joining the first and second members to a cylindrical body portion of a flask. In another feature the method includes wrapping the flask in an external cloth of pre-impregnated composite reinforcement material. The method including weaving the cloth to have non-uniform properties. In another feature, the method includes curing the non-planar assembly so formed.

In another aspect, there is a method of manufacture of a non-planar assembly. The method includes obtaining a feedstock of web material in which at least a portion of the web material defines a first member, the web material has at least one surface having an array of hooks formed therein from the web material itself; engaging a second member to the array of hooks, the second member being a cloth member; and plastically deforming the first member to a self-sustaining non-planar condition, whereby the cloth member takes on the same non-planar condition as the first member. In a further feature, the method may include the step of curing the cloth member after engagement to the first member.

In another aspect there is a method of making a pipe. The method includes forming a core defining a longitudinally extending conduit wall; positioning hollow cylindrical members about the conduit wall; mating a skin to the hollow cylindrical wall, the skin being made of a harder material than the hollow cylindrical members, the skin having a roughened surface array of hooks formed of the material of the skin itself; and engaging the roughened surface array in at least partial embedment engagement with the hollow cylindrical members.

In another feature, the core has a set of external flutes, and the hollow cylindrical members seat between adjacent ones of the flutes. In another feature, the hollow cylindrical members are wound with a helical lay about the conduit wall. In a further feature, the hollow cylindrical members define an outer layer of hollow cylindrical members; the method includes positioning an inner layer of hollow cylindrical members inside the outer layer of hollow cylindrical members arrayed about the core. In another feature, the method wherein the inner layer of hollow cylindrical members is position with a different helical lay from the outer layer.

### BRIEF DESCRIPTION OF THE ILLUSTRATIONS

These and other features and aspects of the invention may be explained and understood with the aid of the accompanying illustrations, in which:

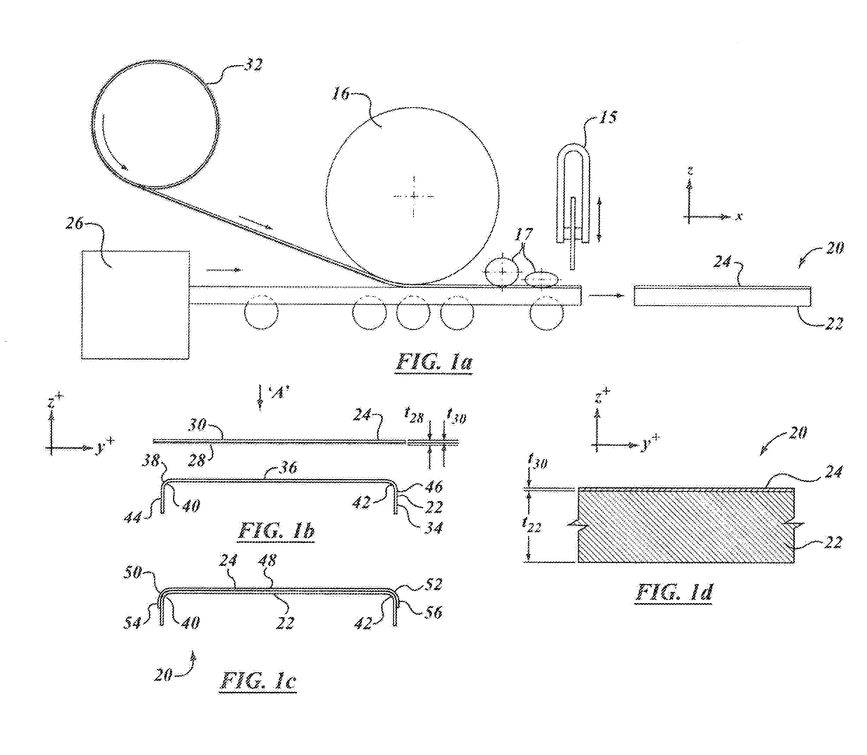

FIG. 1a is a general schematic view of production line for mating members mechanically according to an aspect of the invention herein;

FIG. 1b is a cross-sectional view of two materials prior to mechanical interconnection in the production line of FIG. 1a;

FIG. 1c is a cross-sectional view of the two materials of FIG. 1b as joined together;

FIG. 1d is an enlarged detail of the cross-section of FIG. 1c;

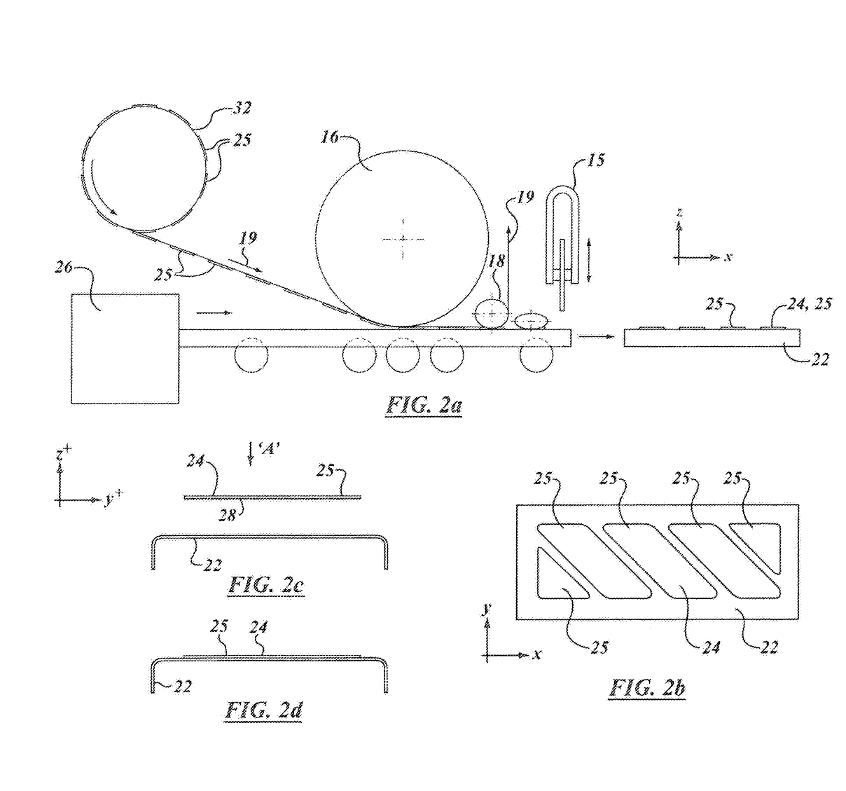

FIG. 2a is an alternate form of production line to that of FIG. 1a;

FIG. 2b is a top view of a product assembled in the production line of FIG. 2a;

FIG. 2c is a cross-section of the product of FIG. 2b prior to assembly;

FIG. 2d is a cross-section of the product of FIG. 2b as assembled;

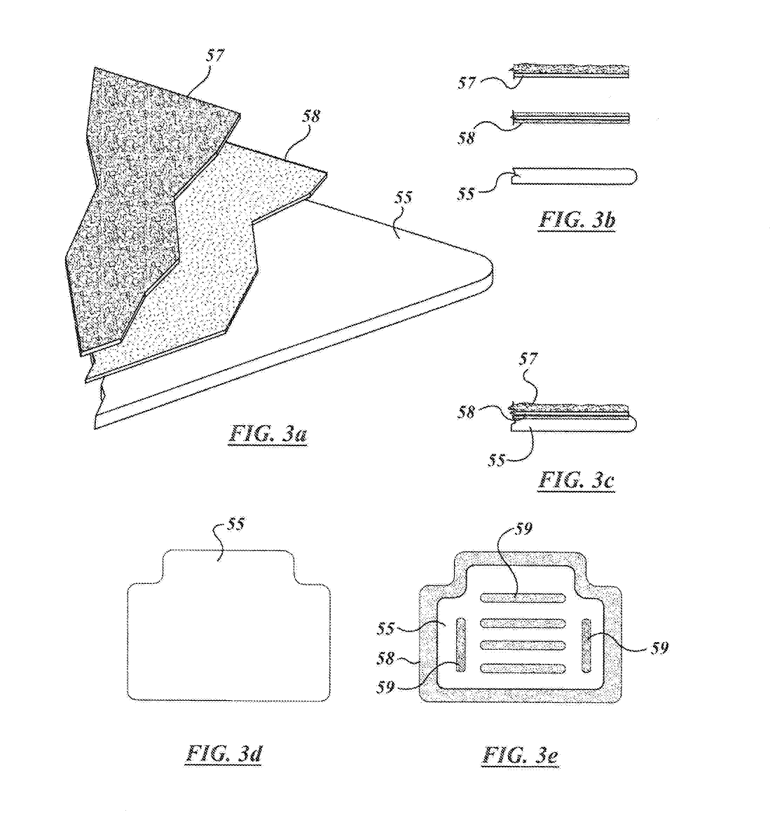

FIG. 3a is a perspective view of a portion of a three element panel with elements separated and in partial scab view to reveal the layers;

FIG. 3b is a partial side view of a section of the panel of FIG. 3a before assembly;

FIG. 3c is a partial side view of the items of FIG. 3a after assembly

FIG. 3d is a plan view of the panel of FIG. 3a;

FIG. 3e is a plan view, with cover removed, of an alternate to the panel of FIG. 3a;

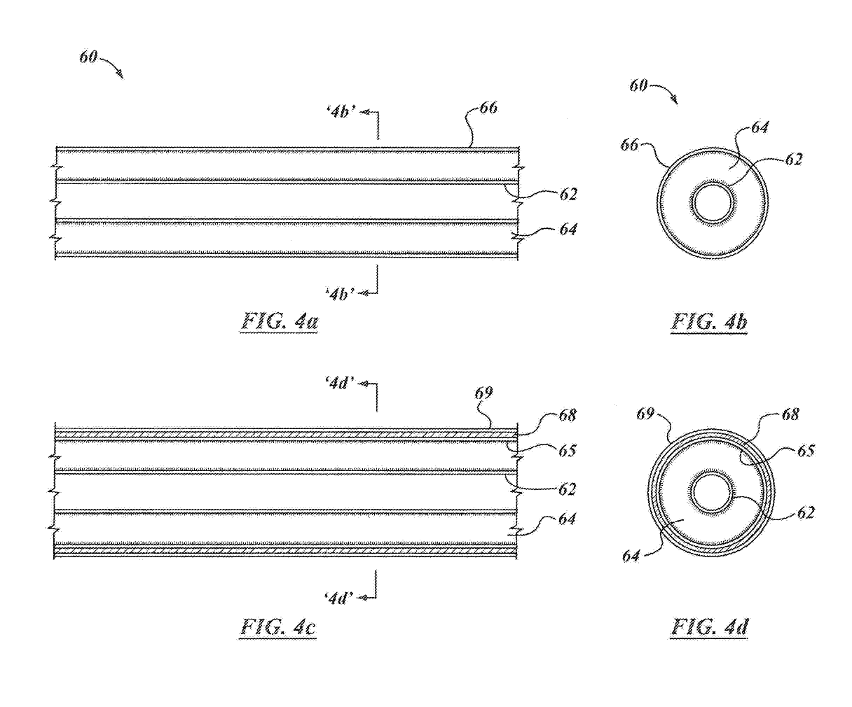

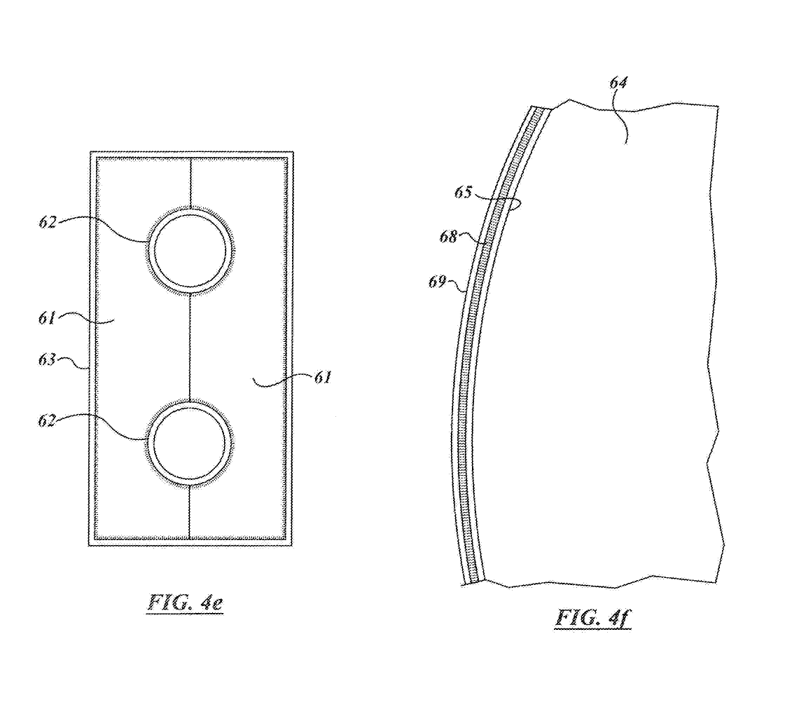

FIG. 4a is a longitudinal section in elevation of an alternate assembly to produces produced by the production line of FIG. 1a;

FIG. 4b is a cross-wise cross-section of the assembly of FIG. 4a;

FIG. 4c is a longitudinal section in elevation of an alternate assembly to that of FIG. 4a;

FIG. 4d is a cross-wise cross-section of the assembly of FIG. 4c;

FIG. 4e is a cross-section of an alternate assembly to that of FIG. 4a;

FIG. 4f is a detail of an alternate embodiment of the assembly of FIG. 4c;

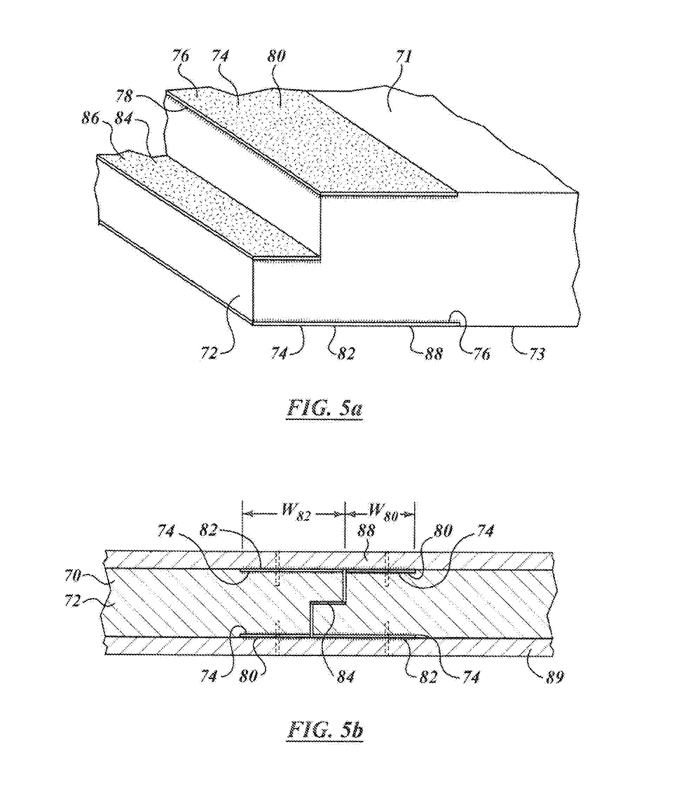

FIG. 5a is a perspective scab view of a portion of an alternate assembly to that of FIG. 4a;

FIG. 5b is a cross-section of two joined assemblies according to FIG. 5a;

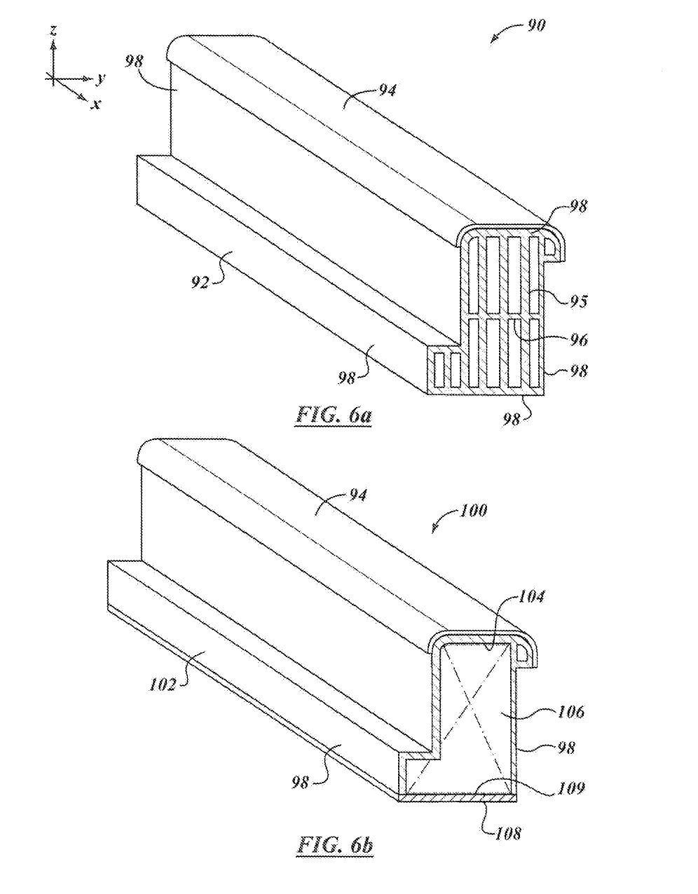

FIG. 6a is a perspective, sectioned view of an alternate assembly to that of FIG. 4a, being a non-planar two-component assembly;

FIG. 6b is a view similar to FIG. 6a of an alternate non-planar three-or-more component assembly;

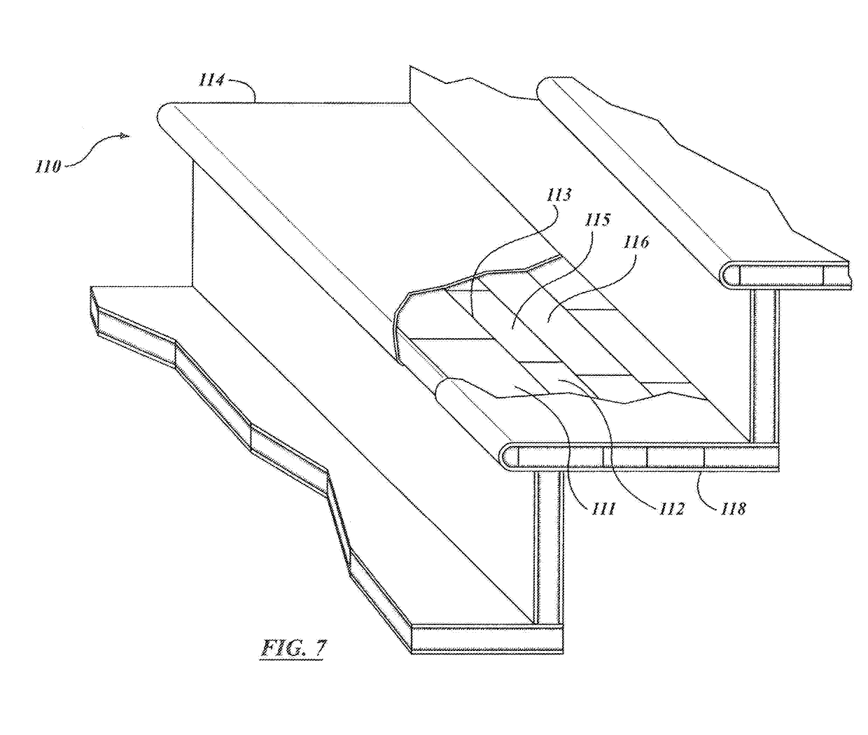

FIG. 7 shows a perspective view of an alternate assembly to that of FIG. 5a;

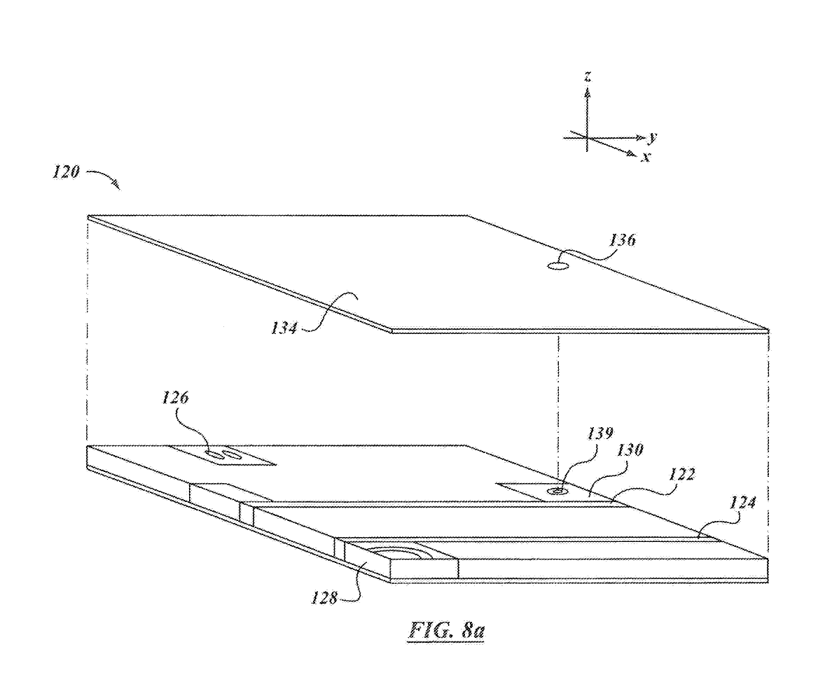

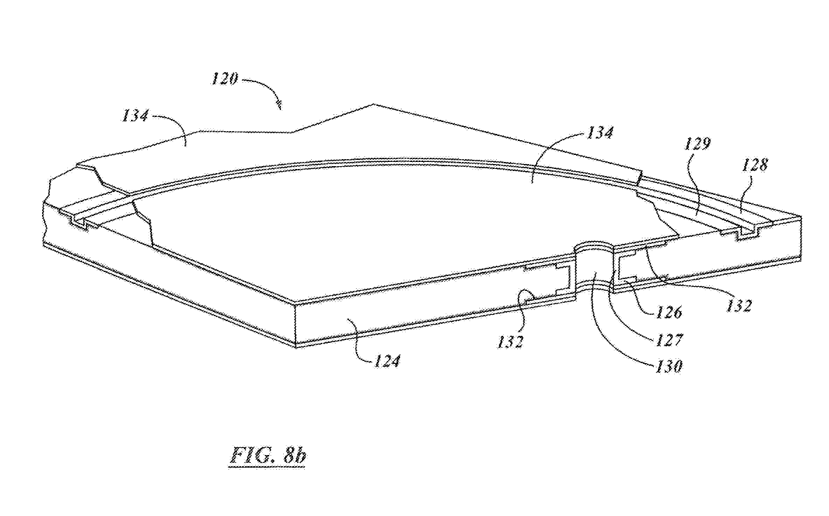

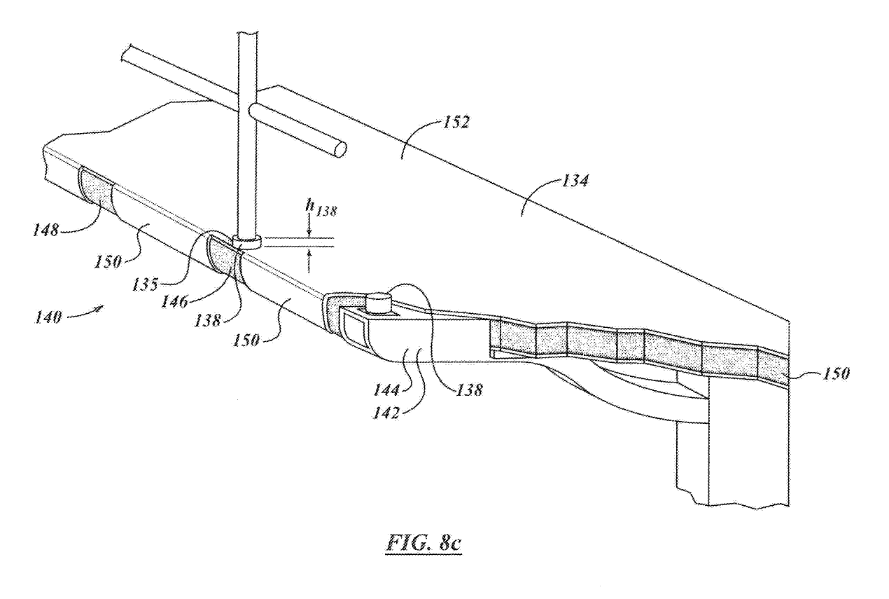

FIG. 8a shows an exploded perspective view of a further alternative embodiment to that of FIG. 5a;

FIG. 8b is an enlarged detail of a feature for a multi-layer structure such as that of FIG. 8a;

FIG. 8c is a detail of a grid or array structure such as that of as aft alternate embodiment to that of FIG. 8a;

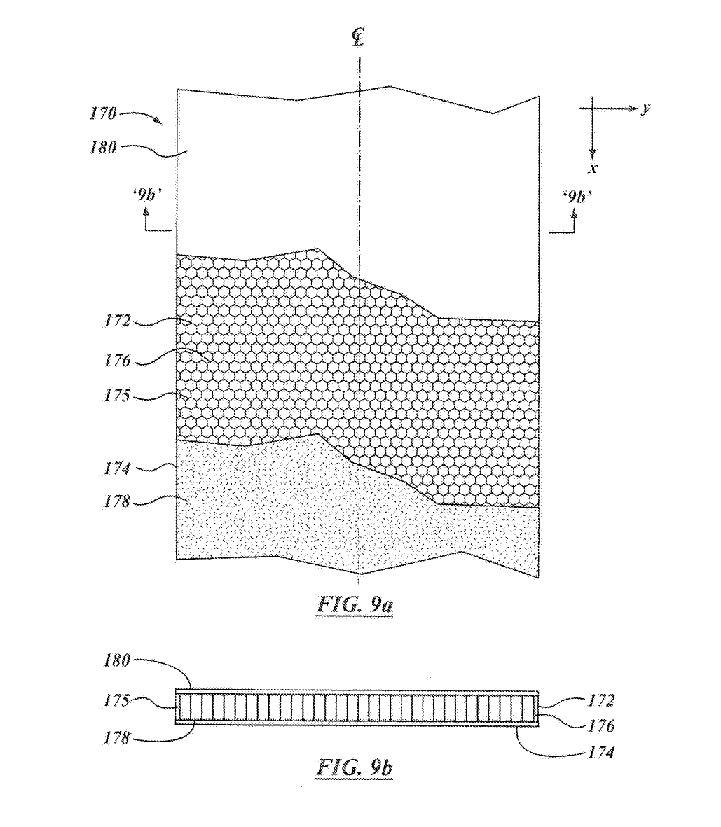

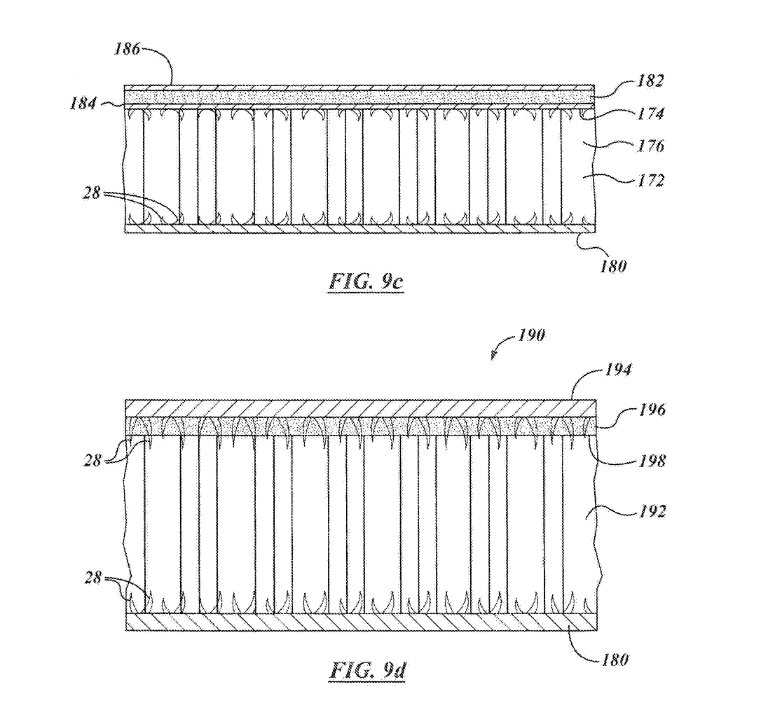

FIG. 9a is top view, in scab section, of an alternate embodiment of assembly to that of FIG. 4a;

FIG. 9b is a cross-sectional view of the section of FIG. 9a taken on ‘9b-9b’;

FIG. 9c is an enlarged cross-sectional detail of an alternate wall section to that of FIG. 9b;

FIG. 9d is an enlarged cross-sectionals detail of a further alternate embodiment to that of FIG. 9b;

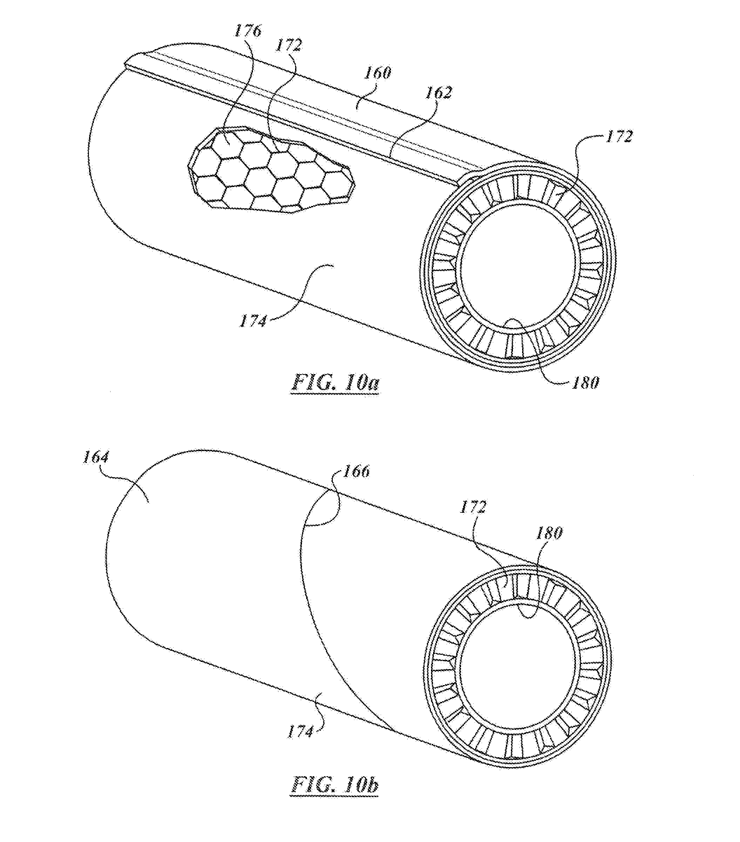

FIG. 10a is a perspective view of an alternate assembly to that of FIG. 4a, with part of the outside wall removed to reveal interior details:

FIG. 10b is a perspective view of an alternate assembly to that of FIG. 9a;

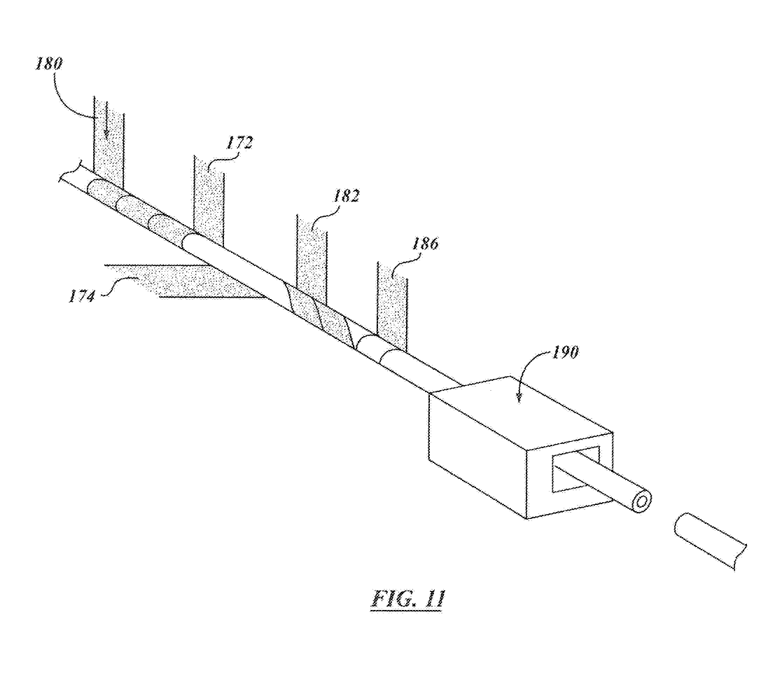

FIG. 11 shows a production line for fabricating cylindrical assemblies such as the assembly of FIG. 9b;

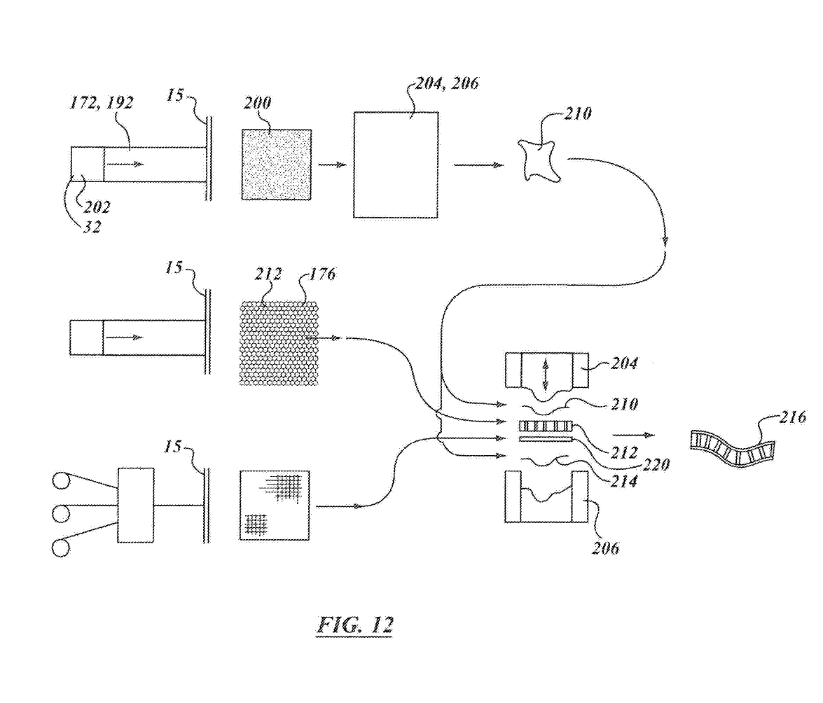

FIG. 12 is a schematic representation of a production line for making mechanically attached laminated assemblies as an alternate to the production lines of FIGS. 1a, 1c and 6;

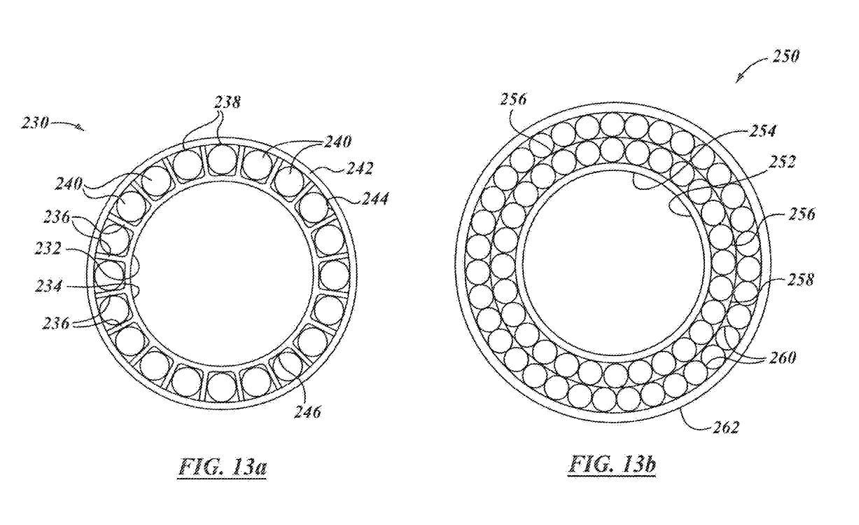

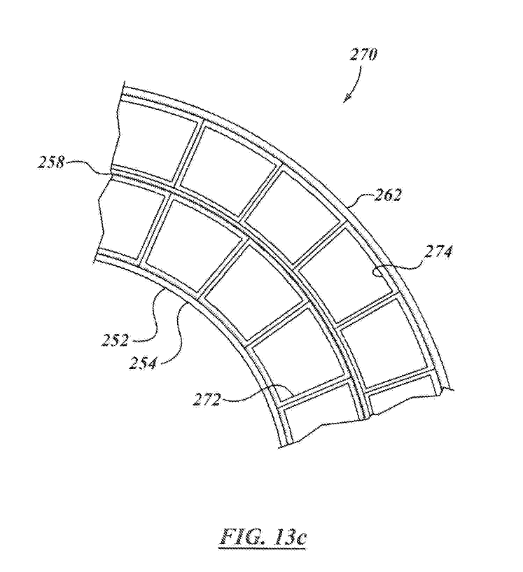

FIG. 13a shows a cross-section of a pipe assembly with longitudinally running wall members;

FIG. 13b shows a cross-section of an alternate pipe assembly to that of FIG. 13a;

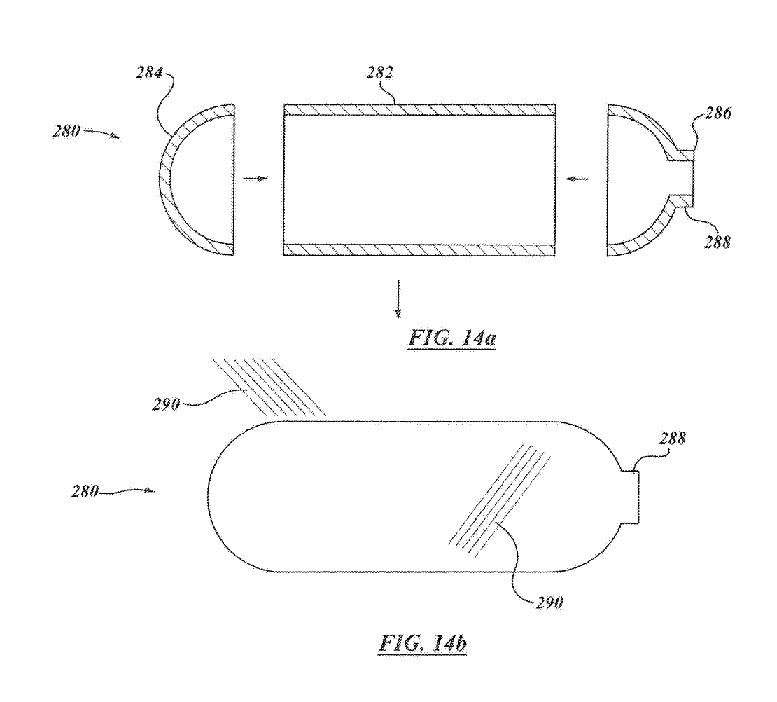

FIG. 14a is a longitudinal cross-section prior to assembly of laminated parts such as made by the production lines of FIGS. 6 and 8;

FIG. 14b is an external elevation of the assembly of FIG. 14a.

### DETAILED DESCRIPTION

The description that follows, and the embodiments described therein, are provided by way of illustration of an example, or examples, of particular embodiments incorporating one or more of the principles, aspects and features of the present invention. These examples are provided for the purposes of explanation, and not of limitation, of those principles, aspects and features of the invention. In the description, like parts are marked throughout the specification and the drawings with the same respective reference numerals. The drawings may be taken as being to scale, or generally proportionate, unless indicated otherwise. In the cross-sections, the relative thicknesses of the materials may typically not be to scale, with the thickness of cladding materials typically being substantially exaggerated for the purposes of explanation.

The scope of the invention herein is defined by the claims. Though the claims are supported by the description, they are not limited to any particular example or embodiment, and any claim may encompass processes or apparatus other than the specific examples described below. Other than as indicated in the claims themselves, the claims are not limited to apparatus or processes having all of the features of any one apparatus or process described below, or to features common to multiple or all of the apparatus described below. It is possible that an apparatus, feature, or process described below is not an embodiment of any claimed invention.

The terminology used in this specification is thought to be consistent with the customary and ordinary meanings of those terms as they would be understood by a person of ordinary skill in the art in North America. The Applicant expressly excludes all interpretations that are inconsistent with this specification, and, in particular, expressly excludes any interpretation of the claims or the language used in this specification such as may be made in the USPTO, or in any other Patent Office, other than those interpretations for which express support can be demonstrated in this specification or in objective evidence of record, demonstrating how the terms are used and understood by persons of ordinary skill in the art, or by way of expert evidence of a person or persons of experience in the art.

In this discussion it may be helpful to make reference to a Cartesian co-ordinate system of length, width, and thickness. Many of the materials discussed herein may be supplied in roll form, or in the form of sheets. In general, the direction of unrolling, or the direction of advance of feedstock, may be considered the lengthwise or x-direction. The breadthwise or widthwise dimension of the roll perpendicular to the direction of advance, may be considered the y-direction. The through thickness of the material may be considered the vertical or z-direction. Many of the materials are supplied in a flexible web form in which the through-thickness dimension is small, or very small, as compared to either the running length in the x-direction, or the width in the y-direction.

There is also discussion in this description of cylindrical objects or extrusions, or assemblies. In such circumstances it may be appropriate to consider a cylindrical polar co-ordinate system in which the axis of rotation of the body of rotation, or the direction of advance of the workpiece, of extrusion, of cylinder, as may be, may be considered the axial or x-direction. The perpendicular distance from the x-axis is defined as the radial direction or r-axis, and the angular displacement is the circumferential direction, in which angular distance may be indicated as theta.

There is also discussion of assemblies formed on a spherical or hemi-spherical shape, in which distances from a center of revolution are measured along the radial or r-axis, and angles may be measured from a central pole in azimuth, and circumferentially.

The commonly used engineering terms “proud”, “flush” and “shy” may be used herein to denote items that, respectively, protrude beyond an adjacent element, are level with an adjacent element, or do not extend as far as an adjacent element, the terms corresponding conceptually to the conditions of “greater than”, “equal to” and “less than”.

The discussion pertains to the use of various materials. There is reference to non-metallic materials. Those materials may include polymers, and the polymers may include thermoplastic polymers, such as polyurethanes, polycarbonates, polyester, or polypropylenes or Nylon™, and thermo-setting polymers such as thermo-setting polyester, or polyurethane. The materials may pertain to composite materials employing a reinforcement, be it glass or graphite or aramid fiber, and to polymer resins suitable for use with the reinforcement fibers. In some instances, the fibers may include both reinforcement fibers and resin fibers, and, in some instances, the cloth may be in a green (i.e., pre-cured) state. Other materials may be metals. Most commonly in this description the metals may be aluminum or aluminum alloys, mild steel, or stainless steel. However, the metals may also include copper and its alloys, bronze, brass, nickel and nickel alloys, chromium and chromium alloys, magnesium, and titanium. The metals may include alloys that are difficult to forge or to weld.

This description discusses assemblies of dissimilar materials. The mechanical interconnection of dissimilar materials may permit the connection of materials that may be otherwise difficult to join, whether because they present difficulties in terms of the use of glues or bonding agents, whether they are not compatible in terms of a thermal welding, curing, or fusing process; whether a thermal process would result in embrittlement, or cracking, or undesired changes in other material properties; whether a temperature dependent or time dependent procedure may be a rate limiting step in manufacture, or may require special equipment, or may consume more energy, or may require the off-gassing of chemicals, or such other reason as may be. That is, there may be many reasons why a mechanical interconnection process may be chosen, whether as a permanent attachment, as in lieu of a chemical or thermal bonding process; or as a temporary, or parallel attachment to be made prior to or contemporaneously with a chemical or thermal bonding process, or as a precursor step to a chemical or thermal bonding process.

In general, in the various combinations of dissimilar materials herein, there will be, at least, a first member and a second member. The first member may typically be the main or matrix member, and may be the relatively softer material. The softer material may be in a “green”, i.e., uncured, state. The second member may typically be a skin, or wall, or membrane, member that is stronger or harder than the first member, where “stronger” or “harder” may mean having a higher yield strength, or having a higher Young's modulus, or having a higher hardness. Prior to interconnection one, or the other, or both, of the materials may be of very little stiffness in respect of out-of-plane bending. That is, one or the other, or both, may be web-like in terms of in-plane tensile stresses, but may have little or no ability to transmit a bending moment. Further, prior to attachment, one or the other, or both, may be quite “stretchy”, i.e., relatively susceptible to in-plane stretching or deformation, whether elastic or resilient, or plastic. The term “out-of-plane” may also be applied to panels that are not precisely planar, but where a bending moment is to be transmitted and the deflection is normal to the tangent of the surface at the given location. I.e., a web or membrane may not necessarily be planar, and an out-of-plane direction or moment or deflection may be understood to be transverse or normal to the local slope of the web.

In each combination, the harder, or stronger, material has an array of mechanical interconnection members. Materials of such nature are shown and described in WIPO publications WO 13/177667 of Arbesman et al., and WO 13/188951, also of Arbesman et al. These interconnection members can be thought of not so much as discrete, free-standing, lonely individual hooks, but rather as a relatively dense array of barbs that is conceptually similar to the male hooks of the commonly known fabric fastening strips identified as Velcro™, but rather than being made of fabric, the hooks are made of a hard, substantially rigid material. In most of the discussion that follows the hooked member is a metal member. However, in some circumstances it may be a plastic member made of a high density, relatively high stiffness polymer used in combination with a softer material. Materials of this nature are advertised commercially under the “Nucap NRX” trademark, and as seen at the website www.nrxfacrtor.com. The hooks may be quite small. That is, their height from the base web, or skin, may be in the range of 30/1000″ to 70/1000″, or between 150% and 300% of the thickness of the sheeting generally, with a density of between 30 and 200 pointed structures per square inch, as indicated by Arbesman et al. The receiving material, be it metal or plastic, may in some embodiments be formed to have fabric-like loops of material analogous to the female loops of a Velcro™ female fabric fastening strip or cloth.

It may be noted that Arbesman el al., show and describe hooks, or prongs, or barbs, or “pointed structures”. They may be referred to as protruding members, or mechanical interlocking members that embed in the softer material. The points not only stand outward of the sheeting, but they also tend to be pointed, or to curve, in one direction along the sheet. The direction of bias is arbitrary—it can be in the x-direction, whether forward or rearward, or in the y-direction, whether left or right, or on the diagonal, or in several directions in combination. However the protruding members may be, they may tend to be “one way” in the sense of permitting embedment or engagement, and resisting disengagement. Their purpose is to make an intimate mechanical interconnection between the two dissimilar materials. It may be noted that this interconnection may tend not to require lay-up, or vacuum bags, or a curing time in an autoclave.

Pronged or barbed, or hooked arrays may be distinguished from Z-pins such as shown and described in U.S. Pat. No. 6,436,507 of Pannell, for example, or the pins of a “pin belt” such as described in U.S. Pat. No. 4,528,051 of Heinze et al. In the Z-pin structures, the pins are separate elements that are built into, and reinforce, adjacent laminate structures. In the pronged arrays of Arbesman et al., the prongs are formed from the parent material, which is typically though not always a metal, and deformed to stand predominantly upward, the parent sheet and the prongs being a monolith, the prongs being portions of the monolith that have been plastically deformed by mechanical deformation. There is no need to bond the prongs to the sheets, given that they are integrally formed with the sheeting. Moreover, their formation does not involve the melting or curing of either resins or polymers, or metals, but rather a mechanical deformation process. It also does not involve a chemical or other process of growing crystals, or “whiskers”, or a cemetitious process, as in U.S. Pat. No. 5,376,598 of Preedy et al., dependent on drying or curing, i.e., such as may make the rate of production critically dependent upon a heating, curing, drying, or time-dependent chemical bonding step or process.

The existence of the sheeting material is of some significance herein. That is, the sheeting defines a base plane, or base surface, or interface, or datum, or backing, or web. In some embodiments, discussed below, the sheeting material is used to form an external skin on the softer matrix material. In those circumstances it may be important that the skin be imperforate, whether to keep out moisture, to protect the underlying matrix, to present a smooth clear surface finish of a salable finished product, to present a cleanable surface, and so on. In other circumstances it is the strength of the material of the sheeting that is desired, as a hard wear surface; or as a flange to take stress in tension or compression; or as a membrane or membrane backing to contain a fluid under pressure. The “hooks” in these materials are formed in a plastic deformation, or slitting, or carving process that raises the hooks out of one face of the parent material of the web member itself. The process may not form apertures through the web. Thus the surface of the opposite side may not be marred or punctured, leaving a “good-one-side” unblemished exterior surface finish.

In the discussion herein, the pronged material may have prongs on one side, or face, or may have prongs on both faces. Whereas a good-one-side finish may be used as the exterior of a finished article, a sheet or web that is pronged on both sides may be an intermediate element in a multi-layer structure.

Reference is made herein to insulated members. For the purposes of this discussion, a variety of commercially available thermal insulation materials could be used. Unless stated otherwise, the insulation members are made of expanded rigid foam, such as EPS (expanded polystyrene), although other foams could be used, and, subject to the needs of manufacturing processes, a less rigid material might also be employed in some instances.

Referring to FIGS. 1a to 1d, a production line produces a generally longitudinally extending assembly 20. Assembly 20 includes at least a first member 22, and a second member 24. First member 22 may be considered the main, or body, or matrix member of the assembly. Second member 24 may be considered the web, or skin, or reinforcement, or surface, or wear surface, or flange. Second member 24 has a first side, or surface, 26 that has been processed to have an array of mechanical embedment members, or features 28, such that surface 26 may be referred to as a roughened surface, or an attachment surface. Those embedment features 28 are such as may be driven into first member 22 to form a mechanical attachment thereto. As noted above, the embedment features 28 may have the form of hooks, or prongs, or barbs, by which names features 28 may also be called. Features 28 stand outwardly of the surface of web 30 by some distance. That distance, h₂₈, may typically be in the range of 1 to 3 times the through-thickness t₃₀ of web 30. The hooks or barbs 28, may stand predominantly normal (i.e., generally perpendicular) to web 30. They may not stand precisely square to web 30, but may have a slant, or cant, and the tip may be bent, not unlike the somewhat curled tip of a carpet tack. In some embodiments the slant or cant of all of features 28 may be the same. In others, some sharp tips may face in the +x direction, some in the −x direction. Alternatively, the tips may point cross-wise in the y-direction, whether only to one side (be it left or right), or to both sides. In some embodiments there may be a combination with some points slanted in the x-direction, and some points slanted in the y-direction, + or − as may be. While other shapes could be used, shapes such as the barbed shape described may tend to permit the prongs to be driven forward, e.g., in the z-direction, into the material of first member 22, thereby engaging it, while tending to resist backward motion such as might otherwise permit members 22 and 24 to disengage. In that sense, features 28 may be thought of as “one-way” fasteners or attachments. It may be that web 30 is quite thin—of the order of 10-20 thousandths of an inch, as when member 24 is employed as a surface veneer. In other embodiments web 30 may have more substantial thickness.

First member 22 may be produced in many different ways. If may be a casting, it may be a stamping or forging. It may have been blow molded or rotationally molded. In some embodiments first member 22 may have a distinctive direction of production, which may be designated as the x-direction, and which may typically align with the longest dimension of member 20, though this need not necessarily be so. In particular there may be an x-direction where member 20 has been produced by a rolling or drawing process, or by extrusion or pultrusion through a die, notionally indicated as 26. The feedstock of first member 22 may be carried forward on a conveyor, or on support rollers, indicated generically as 23. Assembly 20 may be cut to length, as by a shear or other cutting head, 15, either before or after second member 24 is attached.

Second member 24 may be delivered in the form of a continuous web, or strip, that has features 28 pre-formed, and may be paid out, or un-rolled, from a reel of feedstock 32.

Where member 22 is delivered as running stock that is paid out lineally, as from a roll or reel, or that is received directly from a die, second member 24 may be attached in a continuous process, such as roll forming. In some embodiments member 22 may be delivered as a substantially planar web of feedstock. In other embodiments, on delivery member 22 may have a cylindrical cross-section, or may be passed over rollers or through dies forming it to have a cylindrical shape, or a shape formed on a curve, or non-planar external surface that is fed forward as a constant section. Second member 24 may be applied in a substantially planar configuration, as a planar surface to a correspondingly planar surface or surface portion or surface region, of member 22. Alternatively, second member 24 may be roll-formed to mate member 22 on a non-planar cross-section.

For example, first member 22 may have a cross-sectional view 34 in which can be seen the edges of a first surface region 36 and a second surface region 38. First surface region 36 may be planar, e.g., in the x-y horizontal plane, and may define a first side of member 22. Second surface region 38 may be non-planar, and may be, for example, a corner radius of 40 that is tangent to region 36, and that is, in the example, a partial arc of a cylindrical surface formed about the x-direction axis of the radius of curvature. Member 22 may also have another surface region defining second corner radius 42. There may be a fourth surface region to which corner radius 40 is also tangent, that fourth region defining a second side 44 of cross-section 34; and a fifth surface region to which corner radius 42 is also tangent region, defining a third side 46 of cross-section 34. In the example, second and third sides 44, 46 may be planar and may lie in vertical, x-z planes. Member 22 may have further corners and sides, as may be. In the general case, the sides may be planar, or may themselves have a curve or arc, or step. The various sides may be at right-angles to each other, or may be angled or sloped at non-square angles. One or another of the sides may be formed as a quarter-round, or half-round, as may be. For the purposes of simplicity of description, member 22 may be taken as being substantially rectangular in section, as shown.

On installation, second member 24 may be forced into engagement with member 22 by a reciprocating press, or by being passed through the nip of a main roller 16, and past rolls of a roll former, as at 17 such that, a member 24 has a first portion 48 that is planar, corresponding to region 36, and second and third portions 50, 52 that are curved to correspond to corner radii 40, 42. Second member 24 may also have further regions 54, 56 that correspond to a portion or all of sides 44 and 46, and so on. In the embodiment illustrated in FIG. 1c, member 24 forms a surface cladding of curved section on member 22. In one embodiment, the section so formed may be cut to length to define, for example, running board sections for use on automobiles, or other items. In such an embodiment, member 22 may be made of aluminum or a polymer, be it polyurethane or polypropylene, and member 24 may be made of stainless steel, and may form a wear plate or wear surface, or tread, of the resultant object. Alternatively, member 22 may have the shape of a ladder rung, and may be made of aluminum, and member 24 may be a stainless-steel tread for that rung.

Alternatively, it may be that a tread surface is desired only on part of member 22, or only intermittently thereon. In that kind of embodiment, suggested by FIGS. 2a to 2d, member 24 may be delivered in a roll or reel form, 32, in which discrete members 25 are mounted to an adhesive transfer tape or web 19, spaced apart at given distances or pitch spacings to correspond to the size and spacing suitable for member 22. Members 24 are then forced into engagement with member 22, and the transfer tape or web 19 is disengaged, such as by being peeled off by rollers 18, as may be suitable. Although it may be assumed that there is a one-to-one numerical correspondence of members 22 and 24, that need not necessarily be so. There may be two or more discrete members 25 mounted to a single member 22, as eventually cut to length, for example. However many items 25 there may be, the cladding “patch”, or wear plate, or reinforcement, as may be, may have a smaller footprint than the underlying matrix member, whether that footprint is smaller lengthwise or width-wise, or both. The “footprint” may be defined either in terms of the surface area of member 22 covered by member 25, or it may be defined as the projected image of member 25 on the projected image of member 22 as seen along a particular axis, such as the vertical or z-axis in FIG. 2a. That is, while it may be intuitively easy to define a footprint on a plane or cylinder or regular body of revolution, that definition may be less clear where the surface is of a more complex nature, and may include steps or shoulders. Further, while the footprint of member 25 may be an inset that follows the same peripheral shape as member 22, that need not necessarily be so, either, as illustrated in FIG. 2b, and not all members 25 need be of the same shape of footprint, also as illustrated in FIG. 2b. Several members 25 may combine to make a single general shape as in the illustration in which diagonal and triangular members combine to make a generally rectangular overall combined footprint.

Alternatively, member 22 need not be of constant section, and need not be supplied in a web form. That is, a succession of members 22 may similarly be mounted to a conveyor member, or transfer web, at such spacing as may be appropriate, and members 22 and 24 may be forced into engagement, whether by rolls or reciprocating presses, or other similar equipment.

Where member 22 is delivered in a linear form, such as exiting a die, member 22 may be warm at the time of mating with member 24. That is, the residual heat in member 22 may be sufficient that it is at an elevated temperature at which member 22 is softer than it may be at room temperature. Where softer, feature 28 may embed more easily, and the body material of member 22 may flow locally after engagement to complete the engagement. On cooling the engagement of the roughened surface members of item 24 may be held all the more tightly in the matrix of member 22. On cooling, member 22 may be harder than when warm, and may be as hard as member 24 when cold.

In another example, as illustrated in FIGS. 3a to 3e, there may be a substrate 55 to which it is desired to attach a covering 57. In a conventional application, substrate 55 may be a load bearing member or panel such as a deck panel or floorboard panel of an automobile, particularly such as may be found in a truck or hatch-back, or station wagon or fold-down seat back. A roughened or hooked surface member 58 may have hooks formed on both surfaces, as shown in FIG. 3b. When the three parts are assembled in a sandwich, and pressed together either in a reciprocating press or between rollers, the hooks on one surface of member 58 embed in substrate 55, and the hooks in the opposite face embed in covering 57 as shown in FIG. 3c. Substrate 55 may be a high density plastic, such as a UHMW material. Covering 57 may be carpeting or cushioning, and the pronged hooks of hooked surface member 58 may embed in the backing layer of covering 57. This process may occur while one, the other, or both of items 55 and 57 are warm though not melting. Member 58 then functions as a mechanical interface member in place of glues or adhesives such as might otherwise be used. The footprint of member 58 may be co-extensive with the footprint of members 55 and 57, as in FIG. 3d. Alternatively, member 58 may extend in a peripheral band about the edge of member 55, and may have intermittent internal securement strips 39, as suggested in FIG. 3e, whereby covering 57 may be secured about its edge to substrate 55, and possibly also in suitable internal spacings as at internal strips 59. In either case, the mechanically interlocking assembly may tend to permit fabrication without glues, and without curing time. That is, the rate of production is a function of mechanical attachment time in a press, passing through a nip between rollers, or being stamped, rather than curing time.

Member 22 may be round (i.e., circular) in section, and member 24 may be wrapped around member 22 to form a solid rod or hollow tube. For example, as shown in FIGS. 4a and 4b, a structural assembly 60 may have a central core member 62, which may be a pipe, be it copper or PVC, or some other material, or an electrical conductor or wave-guide, be it solid or flexible, that is surrounded by an insulating layer 64, which may be an electrical insulator, or a thermal insulator, or both, which may be surrounded by an external member 66. In this arrangement, external member 66 may have a barbed inner surface, such as surface 26, that is roll-formed onto the softer insulating material. Member 66 may be axially roll formed, or it may be helically wrapped. Where insulating layer 64 is low density polystyrene, external member 66 may be higher density PVC, or Nylon™ or such as may be, such as may tend to provide a tougher, more robust, more wear resistant, external skin or protective layer. Alternatively, the external skin may be aluminum, or stainless steel, or copper, as may be suitable. In some embodiments the outside of core member 62 may be also be a roughened or barbed surface to which an insulation or spacing member, such as layer 64 is applied. There may be more than one pipe or conductor, or linearly extending member 62 contained within insulation member 64, and the overall shape of assembly 60 may be non-circular, be it oblong, or oval, or rectangular in cross-section, whether to suit the shape of a bus or ribbon of side-by-side pipes or conductors, or to suit a bundle of pipes or conductors, or to suit the shape of a cable-way, or race-way, or chase, or conduit, into which such a bus or ribbon or bundle might be seated. It may be that the external skin member 66 is a different material from the internal core member 62. It may be that they are the same material. It may also be that where the insulation material is electro-magnetically transparent if the core material and the external skin material are electrically conductive the assembly so formed may define a wave-guide. Although FIGS. 4a and 4b illustrate members of circular section, this need not be so. One or both of members 62, 66 could be non-circular, e.g., square, rectangular, oval, oblong, and so on, the one being nested within the other. Further, although such nesting may be concentric as in FIGS. 4b and 4d, or symmetrical, as in FIG. 4e, as may be, this need not necessarily be so. As in FIG. 4e, there may be more than one internal member nested within an external wall, with the insulation material being shown as 61 and the external member with roughened surface being shown as 63.

In the embodiment of FIGS. 4c and 4d “second member” 65 is barbed on both inner and outer walls. An external layer or wrap 68 is mounted about (and could be extruded onto, the outside of second member 65. This layer or wrap 68 could have a good external finish, and could define the outside finish of the apparatus. In such an embodiment, second member 65 might be a metal member, be it copper, aluminum, mild steel, or stainless steel. The outer layer or wrap might be a polymer sheet or coating, or thermal or electrical insulator, or a non-scratch surface, such as nylon.

However, wrap 68 might not be the outer surface. Rather, as shown in FIG. 4f, wrap 68 may be an intermediate member to which a further external member 69 may be mounted, with member 69 being barbed to engage wrap 68, and possibly to mutually engage with the barbs of second member 65. In this example, the thickness of each of members 65, 68 and 69 may be small, or very small, as compared to the external radius of the outside skin of member 69 when the assembly is complete. As such, members 65, 68 and 69 may co-operate to define what may be in essence a laminate skin, or shell, of three (or perhaps more) layers, with local resistance to buckling of the skin being provided by member 65 acting as an inner flange, member 69 acting as an outer flange, and member 68 acting as a shear transmitting web between members 65 and 69. In such an example, one, or both, of members 65 and 69 may be made of metal, or of a reinforced composite, and member 68 may be a softer material into which the barbs of the other materials bite.

Considering the structure more generally, in embodiments in which there are adjacent flanges and a softer intermediate layer into which the barbs of the flanges both engage, if one layer is made up of strips or sections wrapped circumferentially, and the other layer is made of axial strips; or if the strips are on helical biases of left and right hand, and are wound about each other; or, alternatively, if the section is planar, if one flange layer is made of strips or ribbons running in the x-direction, and the other layer is made of strips or ribbons running in the y-direction, assuming the intermediate thickness to be small relative to the planar extent of the assembly, when the laminate is mechanically clinched together it will approximate a continuous plate, and may tend all the more so to approximate a continuous plate if the adjoining edges of the various strips overlap and clinch into each other.

Alternatively, member 68 may be a composite member itself, whether of matte or of woven fibers including reinforcing fibers and a matrix resin . Member 68 may be assembled in “green” form, and members 65 and 69 may act as forms or self-jigging molds for member 68. In that respect, the webs of members 65 and 69 may be very thin, where curing of a composite of glass, aramid or graphite fiber of member 68 is to give the final strength of the part being obtained once the assembly is cured. In such a process the mechanical assembly is, in effect, the “lay up”.

In a further alternate assembly 70 of FIGS. 5a and 5b, there may be a first member that has the form of a substantially planar board 72. Board 72 may be of a standard size, such as 96″ high by 12″, 16″, 19.2″, 24″ or 48″ wide. Board 72 may be made of an insulating material, such as expanded polystyrene. It may also be a sheet of plywood e.g., of 5/16, ⅜, 7/16, ½, 9/16 or ¾ inch thickness as may be. Rather than being fully encapsulated, or covered, by a barbed material, edge strips 74 may be the “second members” of assembly 70. Edge strips 74 may be applied around all four edges of board 72, or only two edges on each side, whether on the inside face 71 of board 72, or on the outside face 73. Edge strips 74 may be barbed on only the side, 76, that is embedded into the insulation, or they may be barbed on both face 76 and on outside face 78. Board 72 may have a step or channel 84, or tongue-and-groove along opposed edges, such as may be left and right hand vertical edges on installation. On one face, strip 74 is arbitrarily designated as 80, and has a strip of a first width, W₈₀. On the opposite face, strip 82 has a different, smaller width, W₈₂. The sum of the two widths may be equal to the width of a standard framing member. That is, the summation may equal the width of a 2×4 (i.e., 1- 9/16″ actual dimension +/−). The width may also be somewhat wider. That is, it may be intended that the combined effect of strips 80, 82 may mimick, or functionally replace, a stud, be it of soft-wood or of roll formed steel. There is no necessity that strips 80, 82 mimick the geometric form of a stud. As they dispense with the web of the stud, and as the rigidity of the insulation provides substantial resistance to both in-plane shear deflection and to local wrinkling or buckling of the flanges, the same amount of material may be redistributed to the flanges, and the flanges may be made thinner in section and wider.

The difference in the widths of strops 80 and 82 corresponds to the width of the interlocking step or rabbet 84, along the edge of the board. The thickness of members 80 and 82 may be the same as a conventional roll-formed metal stud, perhaps 1/16″, or 3/32″. The strips may be metal, and in one embodiment may be galvanized mild steel strips. When two adjacent boards 80 are placed side-by-side, the effect is of having the flanges of a roll formed stud. So that the adjacent boards 80 may align, and fix themselves in position, step 84 may also have a barbed insert 86 such that when two boards 80 are brought together, as in FIG. 5b, insert 86 engages both of them. Board 80 may have a strip 86 only on one side, be it left hand or right hand, the assumption being that the ether step would be engaged by the strip of the next-adjacent board 80. Insert 86 may be of mild steel, galvanized, but need not be. It could be of a plastic such as polycarbonate, or other suitable material. When adjacent boards 80 are brought together, the opposed strips co-operate as if a roll-formed stud were in place. Strips 80 and 82 are nailable strips, as is insert 86. Strips 80 and 82 may be mounted with their webs flush with the surface of board 72, and roughened surfaces standing very slightly proud (perhaps 0.010-0.030 inches proud).

Where the outside faces of members 80 and 82 are also roughened with hooks a further panel member, such as 88 or 89 can be mounted. Panel members 88 and 89 may be plywood sheets, or gypsum-based wall-board, or one of each, i.e., gypsum board on the inside wall, plywood sheathing on the outside wall. When the external panels are fastened with nails or screws, the external boards will also be driven onto the roughened strips, thus enhancing the attachment at the interface between the panel and the “stud”. The stud is stabilized in-plane in the shear direction by the bulk of the matrix material of member 42, and is stabilised in the out-of-plane bending direction by the co-operation of members 50 and 52 as spaced-apart flanges. A vapour barrier sheet of plastic can also be stretched on the inside face of the assembly.

In FIG. 6a, a different embodiment of assembly 20 may have the form of a hollow elongate member such as an extrusion assembly 90 in which first member 92 corresponds to first member 22, and second member 94 corresponds to second member 24. That is, assembly 90 may be a two-part, non planar member, which may be a longitudinally extending (i.e., x-direction) member of constant section (in the y-z plane). In this context, the length (in the x-direction) may be large as compared to either the width (in the y-direction) or depth (in the z-direction), the width and depth may be of the same order of magnitude. In this example, hollow member 92 may be an extrusion or pultrusion for a door frame or a window frame, or ladder rung, or similar object. It may not be desirable for member 92 to be made of an highly thermally conductive material such as aluminum, since heat loss through windows and window frames (i.e., in the z-direction) is problematic. However, it may be desirable to have a long lasting, UV insensitive, low maintenance, external surface. To that end, member 94 may be made of aluminum, roll-formed to conform to the external, other-wise weather-facing, surface of member 92. Member 92 may be made of a substantially less thermally conductive material, such as PVC, polyethylene or polypropylene. Member 92 may be formed such that internal vertical and horizontal (as shown in the orientation of FIG. 6a, but z-direction and y-direction, more generally) webs 95, 96, and external peripheral members 98 are of substantially the same or similar thicknesses. The voids between webs 95, 96 and 98 may tend to be of low thermal conductivity.

The description thus far has presumed that the second member engages only a surface, or a portion of a surface of a single, monolithic first member or matrix. However, this need not necessarily be so. In another embodiment, shown in cross-section in FIG. 6b, a structural assembly 100 has a first member 102 to which second member 94 is mated as before. However, in this embodiment member 102 is substantially hollow, but is formed with an internal roughened surface 104 having prongs as described above. A low density thermal insulation material member 106, such as may be made of EPS or XPS, for example, is installed in the internal cavity. A closure plate 108, with a roughened internal surface 109 is driven into member 106. Closure plate 108 may perhaps have a simulated wood-grain finish, or veneer, on the exposed face closes off the internal chamber. Closure plate 108 may be configured to engage only insulation member 106, or only the stems of the peripheral wall 98 of member 102, or both. In this example there are three, and possibly four, distinct materials: the external cladding (possibly aluminum) of item 94; the polymer of item 102 (possibly PVC, polyurethane, polyester or polycarbonate); the expanded insulation material of item 106; and the internal finish material, which may be died or painted, of closure member 108.

In the embodiment of FIGS. 7, assembly 110 includes a first matrix or body member 111 and a second matrix or body member 112 that sit beside each other at a common seam, or joint, 113. Collectively, members 111 and 112 may be thought of as the “first member” of the assembly. The “second member”, namely the pronged skin member 114, may conceal the joint between the two, and may form a common flange connecting members 111 and 112 and fixing their relative location. The body matrix may be made, or may include, further body members 115, 116, and so on, and may include an opposite closing member 118, which may define the opposite flange. All of the members internal matrix may be over-spanned by member 114.

In one embodiment assembly 110 may be a stair tread. Member 114 may be a roll formed veneer surface, that may be made of, or may include a reinforced polymer, that may be prepared to have a cosmetic external appearance of a wood-grain, yet that may have enhanced wear characteristics determined by the composition of the composite and resin. Closing member 118 may have the same appearance, or may have a different appearance if not visible when installed, or is a different upper and lower appearance is desired. The internal members 111, 112, 115, and 116 may be salvaged material that might otherwise have been discarded. It may also be understood that rather than being a stair tread, assembly 110 could be as riser, a stair stringer, planking, wall panelling, and so on.

Alternatively, as indicted in FIGS. 8a, and the alternate detail of FIG. 8c, a structural assembly 120 may include a heterogenous collection of internal members, not because the internal members are off-cuts, or discards, but because some internal members 122, 124 have a first function—perhaps to provide thermal or electrical insulation, or sound deadening, or local resistance to in-plane buckling (i.e., wrinkling) of the external skin under compressive in-plane loading, or to prevent-out-of-plane bowing or deflection due to repeated application of distributed loads on the external skin. It may be that other members 126, 128 are located for a different reason. For example, members 126 and 128 may be electrical sockets, light switches or junction boxes. In such an example, members 126, 128 may not have the full depth of section of internal members 122, 124, or of assembly 120 more generally. That is, while internal members 122, 124 may have a depth corresponding to the depth of a 2×4, 2×6, or 2×8 used in framing, or a 2×10 or 2×12 joist, for example, junction boxes, light switch boxes, and so on, may be shallower. Alternatively, structural assembly 120 may require one or more hard points for the transmission or reaction of non-distributed loads e.g., point loads. That is, a post, or bracket, or handle, or stem, or leg, or other structure may be mounted to structural assembly at a connection interface. The connection interface member, be it 126 or 128 may be a threaded insert for receiving a threaded mechanical fastener, or a socket 127, like a mast step in a sail boat, or an eyelet or collar or bushing or bearing, 130, such as may permit translational motion of another member transverse to structural assembly, whether a track, or door hinge, or slide, or shaft.

Alternatively, as in FIG. 8b, member 126 or 128 may be a reinforced member defining a path or trackway 129, or region where higher local stresses may occur, such as where structural assembly 120 may be a ramp for wheel chairs, or shopping carts where local track reinforcement may be required, as by having a relatively shallow local doubler 132 mounted to spread a generally in-plane local point or line load into the plane of the surface, or by having a more substantial or full-depth member, perhaps in the form of a beam or channel that may tend to be more capable of reacting a more concentrated Hertzian load, as in a roller of a slide running on or in a track, whether for a drawer, or door, or window, or for resolving an out of plane concentrated or focal shear load applied in the out-of-plane direction.

In this example, the “second member”, or surface member 134 may be harder than both members 122, 124 (which may be expanded polystyrene), and members 126, 128 which, depending on the physical properties and quality of material required, may be an high density plastic, a cast gray-metal, white-metal, aluminum, and so on. In each case, the underlying material is penetrable by the prongs or barbs of the roughened surface of surface member 120. Doubler 132 may itself have a roughened or barbed surface to engage first member 122. That roughened surface may tend to distribute loading from doubler 132 into first member 122.

Where threaded inserts or sockets, or eyes or through-bores are used, surface member 134 may include pre-cut reliefs, apertures, rebates, slots, and so on, indicated generically as 136, that seat about the opening or other access, as required to engage that interface fitting, whether it is a rigid fastening point or an engagement interface permitting one or more degrees of freedom of motion between the structural assembly and the other associated element. The insert fitting may be entirely covered, other than the necessary functional opening, such that all of the insert lie shy of the external surface of the web of member 134. Alternatively, member 126 or 128 may have a shoulder, as at 138, such that the resulting land surface 139 that lies flush with the external surface of member 134. In the further alternative, the height of shoulder 138, namely h₁₃₈, may be greater than the through-thickness; t₁₃₄ of web member 134, such that land surface 139 stand proud of the surrounding surface of member 134 and constitutes an embossment, or simply a boss, 135. In some instances boss 135 may be externally threaded to define a stud, such as may be one of an army of studs to which another member or assembly may be fastened.

In a three-or-more component systems, as indicated in FIG. 8a, there may be a structural assembly 120 in which there is a first member 122 that is made of a material that is relatively highly elastic, that may not tend to hold its shape or size well, that may be susceptible to thermal expansion or contraction, or that may swell or shrink in the presence of moisture or humidity. Second member 134 may be made of a material that may tend not to be prone, or to be less prone, to swelling or shrinking. It may be that an array of third members is to be located in first member 122. It may be that their locations relative to each other may be of importance, and that there may be a tolerance on the dimensional spacing in x, y, and diagonal measures. In such an instance, first member 122 may be of sufficient stiffness that, when mated to second member 134, first member 122 and second member 134 resist out-of-plane deflection (or such out-of-plane defection may be acceptable), whereas dimensional tolerance in the surface plane or curve of member 134 may not be. In such circumstances, where third members 126, 128 and 130 may be light sockets, junction boxes, and switches, or where they may have sensors, or where they define attachment interface locations, such as threaded inserts or studs, for other objects and mountings whose x-y spacing dimensions are to be controlled, the “second member” defined by web member 134 (while also functioning as a flange or seal, or protective layer) may also function as a datum, or self-jig, or template, of relatively higher in-plane dimensional stability than first member 122, even where the through-thickness of the web of second member 134 is relatively thin.

In a further example in FIG. 8c, a structural assembly 140 may include a grille, or array, or grid 142 of beams, or joist or arms, or ribs 144, 146, 148. Ribs 144, 146, 148 may be hollow section structural members, whether channels or tubes, rectangular or square. The array or grid may be rectangular or radial, or some other pattern as may be. Interstitial filler material 150 fills the spaces between ribs 144, 146, 148. A “second member” 152 may be a sheet or skin with a roughened inner surface that picks up on the tops of ribs 146, and also on the tops of the filling material 150 to form a smooth continuous surface. Second member 152 may be roll-formed about filler material 150, and, in some embodiments, about the ends of second member 152 in whole or in part. The array or grid provides the vertical reaction that supports second member 152, and, whether directly or indirectly, also supports interstitial filler material 150. Interstitial material 150 may tend to discourage or to prevent local bowing or buckling of second member 152. in one embodiment, ribs 144, 146, 148 may be of PVC. Material 150 may be EPS or XPS, or an open- or closed-cell foam, or expanded material. Second member 152 may be a polycarbonate, or aluminum, or other metal. In another embodiment, ribs 144, 146, 148 are aluminum, filler material 150 may be a polymer, and may be an expanded material. Second member 152 may be a harder aluminum alloy, or stainless steel. In general, the filler material is the least hard, the ribs are harder, and the second member is the hardest of the three.

In the embodiment of FIGS. 9a and 9b, there may be a structural assembly 170 in which the first member is identified as 172 and the second member is identified as 174. FIG. 9a is a view from above, with scab sections to show the layers. The x-direction is the direction of advance of the product during fabrication, as through rollers, and so on. In this example, after mechanical inter-connection there is a substantially planar laminate such as may be cut to length. Like first member 92, first member 172 may be hollow. However, rather than having the hollow chambers running in the lengthwise direction of the assembly generally, first member 172 may be formed of, or define, an array of cells 176 in which the cell walls extend away from the large surfaces of the feedstock, or material, predominantly in the through-thickness direction. In a planar object, this may be the z-direction. In a cylindrical object, it may be the radial r-direction, in which instance array of cells 176 may form part of, or all of, an annular member. In some embodiments the cells may be made of an expanded material. In some embodiments the cells may be generally rectangular in section when viewed looking through the thickness. In other embodiments the cells may be hexagonal. Materials of this nature may be referred to as “honeycomb” cores, and may sometimes be sold under the brand names of Benecor, Inc., Victrex APTIV™ or Renolit “Gorcell”. In the embodiment shown, taking second member 174 as extending at least locally in a plane, which may be considered an x-y plane, the webs of the cell members extend in planes normal to the x-y plane, i.e., the webs of the cell walls stand away from the web of member 174. Although the wall thickness of cell walls 168 may be very thin, the density of the small prongs of barbs of inner surface 178 is akin to a continuously roughened surface, and the barbs engage the edges of walls 168. Second member 174 then becomes a flange, and the cell array structure of cells 176 forms a multiple-wall shear web array. That is, it is not necessary for all of the prongs or barbs of the array to interconnect or embed in the adjacent structure, and it is not necessary for the adjacent structure to extend continuously in the plane, or along the surface, defined by the web of second member 174. Here, the membranes of first member 172 all stand on edge relative to the barbed surface. As may be appreciated, if another “second member”, identified as opposite flange 180 having a roughened surface of mechanical engagement members is then mounted to the opposite face of first member 172 the resultant structure will have two spaced apart flanges with the cellular core defining a shear web array. The resultant flanged structure 170 may then define a light-weight floor board, or bending-moment-transmitting panel. Panels of this nature, used for aircraft floorboards, for example, are typically made by a process in which the hexagonal or rectangular cell cores are bonded by resins or glues to the flanges. In the example provided, the spaced apart flanged assembly may be obtained by mechanical inter-connection, rather than glues or resins, and without the time required for heating and curing. It may also be noted that where similar structures are made with composite panels and glues, significant effort may be involved in lay-up and vacuum-bagging of the parts to be assembled. In a mechanical process the lay-up and vacuum bagging steps may tend largely to be eliminated.

In a further alternative embodiment of FIG. 9c, in which, like FIG. 9b, the thickness in the z-direction is exaggerated for the purpose of illustration, both sides of member 174 may have prongs, and the outside skin may be mated with a flange of pre-manufactured composite, be it of a graphite fiber, aramid fiber, or similar, indicated as 182. In such circumstances, web 184 of member 174 may be thin, and member 182 may be applied to member 174 (i.e., to the “outside” face of member 182) before being engaged to member 172. In a yet further alternative analogous to the embodiment of FIG. 4d, a further hooked layer, perhaps a very thin layer 186, may overlie member 182.

In the embodiment shown in the enlarged wall section detail of FIG. 9d, in which thicknesses are exaggerated for illustration, second member 174 may be replaced by second member 194. In assembly 190 there is a layer of a woven member or cloth 196 that is captured between second member 194 and the cell wall edges 198 of first member 192. In this embodiment, the prongs of member 194 are taller than the through thickness of woven member 196 such that they reach through the woven member to the cell wall edges. Woven member 196 may be a cloth woven of strands of reinforcement material, be it glass, graphite fiber, aramid fiber or some other, interwoven with strands of polymer resin. Cloth 196 may be provided in a green (that is to say, un-cured) state. Second member 174 may be made of a thin metal layer, or of a polymer sheet. The mechanical interconnection of members 192 and 194 will define a substantially rigid member, sufficiently rigid to hold its shape during subsequent curing of member 196. The weaving of cloth 196 may have equal spacing of reinforcement fiber and resin strands, such that the resultant eventual cured product may have more or less even and consistent properties in both x and y directions. Alternatively, the weaving of the fibers in the x-direction may be different from the proportions of fibers in the y-direction such that the cloth may have a warp and a weave in which, for example, the tensile strength along the x-axis may be different from (more or less, as may be) the tensile strength along the y-direction.

While assemblies 172 and 192 have been described, and shown in FIGS. 9a and 9b as flat, planar panels in a Cartesian co-ordinate system, they can also be made as curved surfaces, like airfoils, or cylinders, or spars, or masts, such as might be used in sailing or other applications. Such alternate curved-surface cylindrical embodiments are exemplified in a cylindrical-polar co-ordinate system by the cylindrical structures of FIGS. 10a and 10b. In the embodiment of FIG. 10a the cylinder 160 may have an external skin member, such as second member 174, that has a longitudinal, or axial, seam, or seams, as at 162. In the embodiment of FIG. 10b, cylinder 164 has a helical seam, as at 166. In this example, the “opposite flange” 180 of FIG. 9a is the inside cylinder of FIGS. 10a and 10b. Cylindrical pipe assemblies such as those shown in FIGS. 10a and 10b may be made with each of the wall variations shown and described in the contest of FIGS. 9c and 9d. Further, in some instances it may be desired for such pipes to have heterogenous fittings such as indicated in the examples of FIGS. 8a, 8b, and 8c. .Expressed differently, the matrix members of the assemblies of FIGS. 4a-8c could be hollow cell matrices with the cell walls extending away from the flanges. For example, in a cylindrical context, items 130 or 138 may be outlet fittings of a manifold, or tap fittings, or tee-fittings on a pipe for connection to another pipe.

A pipe assembly such as that of FIGS. 10a and 10b may be manufactured according to a process such as seen in FIG. 11. At the start, an internal tube is formed, either by extrusion or some other means. It can be formed, for example, by winding one or more helical strips to form the inside wall. That “strip” could be member 180. The inside wall may have a single thickness, or if may have a double thickness, perhaps by winding a right-hand helix over a left hand helix, possibly with an intermediate member such as in the wall section of FIG. 4f. However the internal tube may be formed, a hollow core, such as a honeycomb core, e.g., a cell array 176, is then wound helically about the internal core, with the body of the array overlapping the helical seam of the internal tube axially to either side, such that the seam of the cell array and the seam of the tube are not coincident. Alternatively, if the external seam of the inner tube or cylinder is on a left-hand helix, the cell array may be wound on a right-hand helix. The external skin, i.e., the “second member” 174 in this example, is then wound helically about cell array 176. Again, the seam of the external skin helix may be offset axially, or wound on the opposite hand, of the seam of cell array 176, and also offset from the seam of the core cylinder. The process can be varied to wind a layer such as 196 on a core 192, or to wind a layer 182 outside of layer 184, and then, optionally, to wind a layer 186 outside of layer 182.

Where a “green” layer of pre-preg composite cloth composed of both reinforcing fibers and strands of uncured resin forms one or more of the layers, the pre-assembled pipe assembly of mechanically interconnected components may be passed through a curing apparatus. The curing apparatus may be an oven 190. The pipe may be cut to length either before or after curing. That is, the curing may be a continuous process as the pipe moves, or, where section have been cut previously to length, several lengths can be collected and cured in an oven at one time in a batch process.

In the alternative embodiment of FIGS. 7, if may be noted that where the barbed skin member is made of metal, that metal may be cut to shape in terms of a footprint in the in-plane direction (i.e., in an x-y plane). That is, the feed-stock materials of skins such as members 174 and 194 may be provided in rolls. Rather than being mated with a continuous web of core materials, such as the feed-stock materials of members 172 and 192, portions of members 174 or 194 may be cut to length, and may be cut to the projected profile, or footprint, of the part that is to be made.

Further, to the extent that the feedstock of members 172 and 192 is plastically deformable, it may be pre-formed to a desired non-planar, possibly non-cylindrical profile of an arbitrary 3-dimensional surface. For example, as in FIGS. 7, a blank 200 of deformable barbed feed-stock 202 is placed between the male and female heads of a forming press, 204, 206, where it is formed to a surface shape, whatever that shape may be. This deformed blank is indicated as 210. Blank 200 then has the impressed shape of dies 204, 206. Blank 200 may have its edges trimmed, as may be suitable, and may then be set aside for future use, or, alternatively, may be moved to the next press station.

At the next press station, plastically deformed blank 210 may be placed in, or on, one or the other of the male and female dies 204, 206, and a web member, 212 may be placed next to it, e.g., on top. Web member 212 may be an open hexagonal or rectangular core cellular array feedstock that has little resistance to bending, such as cell array 176. Member 212 may have been trimmed to an appropriate footprint shape to correspond to pre-formed blank 210. When the press is brought together, member 212 is deformed to conform to the shape of the dies, and, at the same time, to conform to pre-formed blank 210. As with blank 200, member 212 is stretchable in the field of the 3-dimensional surface, until it is bound to the prongs of the flange member defined by member 210. Once mechanically bound, the assembly so formed retains the 3-dimensional shape of the die cavity. This may result in a finished part.

However, alternatively, other layers may be added. There may be a further step, or a further press station, in which another layer of material 214 is added, layer 214 being roughened on the surface facing web member 212, such that when brought together the hooks of layer 214 clinch into member 212, thus forming and a three layer laminate in the next press station, the finished part being designated, as 216. As may be noted, the laminate has been formed through mechanical interconnection rather than through a chemical or thermal curing process. In the example, member 210 defines a first surface or web or flange, member 214 defines a second surface or web or flange that is spaced away from member 210, and web member 212 defines a shear web extending between the two flanges, such that the resultant structure is capable of resisting, or transmitting, bending moment in the plane or arc or span, however it may be termed, of the assembly more generally. Layer 214 need not be the same deformed shape as layer 210, although in some circumstances it could be. For example, it may generally be an offset, or it may be of a smaller (or larger) radius, as when making inside and outside surfaces of a hemispherical member. To this point it has been assumed that hollow cell cores may be of constant through-thickness such that at any point the perpendicular distance between the two opposed flanges is constant. However, in some embodiments the hollow cell core may not be of constant thickness but may be shaved such as to be thicker in some regions than in others, or to be tapered in thickness, and so on, such as much be appropriate for a tapered training-edge of an airfoil, for example.

Recalling the alternate flange embodiments of FIGS. 9b, 9c, and 9d, it may be that a cloth member 220 is provided. The roughened, hooked inner surface of member 214 (or member 210, or both) may have hooks of sufficient length to pass through cloth member 220 and to engage the edges of the walls of hollow celled member 212, such that the mechanically interconnected assembly 216 includes cloth member 220.

Cloth member 220 may be made on a loom or weaving frame or apparatus, indicated generically as 222. The strands of cloth member 220 may include woven reinforcing materials, whether of glass, aramid or carbon fiber, or a mixture thereof; and of strands of uncured polymer resin. In some embodiments the distribution of the reinforcing fibers and resins may be generally uniform, such that the resultant cloth has roughly even properties in the x-direction, or in the y-direction, or both. The properties in the x-direction need not be the same as the properties in the y-direction, depending on the orientation of the in-plane stresses that are expected in the use for which the component is designed. In some embodiments the weaving of the reinforcing strands or fibers may be such as to vary the density or concentration of reinforcing strands locally within the part to correspond to anticipated loads in the part in use. However it may be woven, the supplied feed-stock is cut to shape as at 224, whether with a shear, a high-pressure water jet, or some other suitable means. The cloth is then positioned in the mold, and secured mechanically to the hooked surface of item 210 (or 214, or both, as may be). Again, where the mechanically interconnected assembly included layers in the green state, a curing process may follow. The procedure may tend to reduce or eliminate the need for the use of glues and vacuum bagging, and may tend to reduce lay-up-time to the time required to put pre-cut parts in a reciprocating press. Much of the process may be automated. Hollow cores may be used within the press. One use of the process described above may be to make hemispherical end caps for pressure vessels or for low-thermal conductivity, low thermal loss flasks or vessels. The same, or similar, process may be use for making spouts, pipe tees, tap junctions, elbows, and so on.

It may also be appreciated that the press process could be a repeated process in a single press. In the first step, the outside (or inside) plastically deformable member, typically a metal member is deformed to the desired final part shape. In the second step the cloth and cell array, being of approximately zero resistance to out-of-plane bending, are placed in the press and mechanically interconnected to the hooked inside face of the outside member (or, equivalently, to the hooked outside face of the inner member, depending on whether one is building-up the part from the outside surface or the inside surface). Once the internal members have been deformed, the remaining plastically deformable (typically metal) member is placed in the press, and the final part is made.

In the embodiment of the cross-section of FIG. 13a there is an alternate embodiment of hollow-walled structural assembly, or cylindrical assembly, indicated as 230. There may be a first member 232, which may have the form of an extruded tube 234 having an array of external finwork or fluting 236, in which the finwork or fluting extends radially outwardly from the circumferentially extending inner peripheral wall. In the rebates, or channels, or grooves, or accommodations 238 defined between adjacent flutes or fins, are longitudinally extending members 240. Members 240 may be rods, or may be hollow tubes. In one embodiment they may be copper or aluminum, and they may themselves by wrapped in electrical insulation. In another embodiment, they may be hollow tubes, whether of metal or polymer. In one embodiment they may be Nylon or polypropylene, or polyurethane. An external closing “second member” 242 extends about, and captures first member 232 and the array of longitudinally extending members 240.

In the assembly, the inside face 244 of outside member 242 may be roughened with hooks, as described above. Those hooks may engage the outermost tangent of members 240. Those hooks may engage the radially outermost extremity, or distal tip, of the fins or flutes 236 of the internal first member 232. Alternatively or additionally the bottom wall of the channels between the flutes may be a roughened hooked surface as at 246.

First member 232 may be made out of aluminum, or copper or mild steel. Alternatively, first member 232 may be made of polymer, such as noted above. First member 232 may be made of a food grade material. The inside face 248 of tube 234 may be coated with a chemically inert or chemically resistive coating such as may be compatible, in one embodiment, with use in connection with food or beverages; in another embodiment the coating may resist caustic or acidic chemicals or solutions or slurries, and so on. Alternatively, a chemically resistant liner or a rubber or other membrane liner, may be installed within first member 232. It is not necessary that the number of peripherally arrayed tube members 240 be equal to the number of flutes or fins 236. It may be that two or more rods or tubes seat in a single accommodation side-by-side. It may be that in some embodiments there are only two or three such fins or flutes, such as may be spaced on 180 degree, 120 degree, 90, degree, 72 degree, 60 degree angular spacings and so on. Assembly 230 may, when complete, define a light-weight tube for high pressure fluids. Although the flutes may extend parallel to the x-axis, in alternate embodiments the flutes may be formed helically about tube 234. In some embodiments the radial extent of flutes or fins 236 may be less than the radial extent of tube members 240, i.e., the length of the fin may be shorter than the diameter of the tube.

In an alternate embodiment, a cross section of a cylindrical assembly 250 is illustrated in FIG. 13b, there may be an inner member 252 which may be a hollow member having a continuous peripherally extending wall of closed section (i.e., such as may hold fluids), and which may be indicated as a pipe or tube or liner, 254, which may in some instances by made of a food-grade material, or of any of the materials discussed above. The outside face of member 252 may be a roughened, hooded face as discussed above. A bank or layer or row of cylindrical members 256 may be placed circumferentially about, and may extend lengthwise along, member 252. As before, members 256 may be solid rods, or may be hollow tubes. An interstitial, radially intermediate layer 258 is made of a harder material that is hooked or barbed on at least one of its inside and outside faces. An outer row, or layer, or bank of rods or tubes 260 is mounted radially outside of intermediate layer 258. A closing external wall 262 extends circumferentially about, and encloses tubes 260. The radially inwardly facing wall surface of external wall 262 has a roughened, hooked surface that engages the radially outermost tangent portions of rods or tubes 260.

In some embodiments, the pipes or tubes or rods of the inner layer of cylindrical members 256 may be wound on a handed lay, be it left hand or right hand. The lay may be only a few degrees to left or right, or may be quite substantial, such as 15 degrees or 30 degrees. The other, outer, layer may be wound on the opposite hand, or at any rate on a different angle of lay, such that the integers of the outer layers cross the integers of the inner layers. For example, the inner lay may be 10 degrees right-handed, the outer lay may be 10 degrees left-handed. It is not necessary that the cylindrical members of the inner layer be of the same diameter as the cylindrical members of the outer layer. It is not necessary that the cylindrical members of the inner layer be of the same number as the cylindrical members of the outer layer, and, in general, they may tend not to be of the same number. The rods or tubes need not necessarily be circular. For example, in the partial sectional embodiment of FIG. 13c, an assembly 270 employs radially inner and outer rows of cylindrical members 272, 274 that are of non-circular section. In each case, where hollow tubular members are used, the overall assembly may be a light-weight tube or vessel such as may be able to contain elevated internal pressures.

In FIGS. 14a and 14b there is a combination of a cylindrical or tubular hollow-walled assembly such as made according to FIGS. 13a-13c, or 10a or 10b, with a two three-dimensional members such as might be made according to FIG. 12. That is, in a bottle, or flask, or pressure-vessel assembly 280 there is a main body portion 282, a closed end portion 284, and a spout or outlet portion 286. Main body portion 282 may be cylindrical and may be made as described above. Closed end portion 284 may be made with drawn hooked members and coring, as in FIG. 12. Outlet end portion 286 may similarly be made according to FIG. 12. Outlet end portion 286 may have a threaded spout at 288. The cylindrical center portion and the end cap portions may be assembled by bonding or welding as may be appropriate. The assembled structure may then be wrapped in a reinforced fiber layer 290 to provide a continuous high-strength external skin, and cured. A liner may also be moulded or cast inside the resultant assembly, the liner having suitable properties for sealing, chemical resistance, food and beverage compatability, and so on, as may be appropriate for the intended use.

In each of the embodiments described above, the component members may be assembled in a cold forming process. The term “cold forming” does not necessarily mean room temperature. The temperature of one member or another, or several, may be elevated where the member may be softer at elevated temperature. The reference to “cold forming” is to a mechanical deformation process, rather than a welding or melting process.

In each of these processes, however, an adhesive, or bonding agent, or diffusion bonding or diffusion welding or eutectic welding or diffusion agent, or compatibilizer may be applied to one (or both) surface or side of the materials to be mated together. Such adhesive, bonding agent, etc., may tend to improve or boost adhesion between the two materials being joined, which may be two otherwise seemingly incompatible materials. The mechanical attachment may occur quickly, and may fix the position of the layers relative to one another. The action of the adhesive or bonding agent, etc., may occur over a longer curing time, or may be deferred or delayed pending, e.g., a pass through an oven at higher temperature for curing, or a washing in a chemical activator, with the mechanical bonding of the layers acting as a fixed self-jig for the slower bonding process. The process may be analogous to entrapment of a green or uncured layer between the two layers that are to be mechanically interlocked. The resultant adhesive or eutectic bonding may then secure the objects in addition to the mechanical interlocking of the prongs, and may in some instances provide the dominant attachment mechanism.

In summary, when interlocking happens between plastic and metal by pressing one against the other, it may be that the composite produced based on the mechanical hybrid structure may lose a portion of its strength when subject to extreme environmental conditions of temperature or pressure, or repeated thermal cycling or repeated mechanical loading or vibration. Use of an adhesive or bonding agent, etc., between the two layers, which may otherwise be incompatible, may aid in creating a chemical bond, in addition to the mechanical interlocking, such as may tend better to resist delamination under extreme or cyclic environmental conditions or loading. The adhesive or bonding agent may be applied and may be cured under elevated pressure or temperature.

To recap, the apparatus shown and described includes embodiments of an assembly of materials, that assembly including a first member; and a second member, the second member having an array of mechanical interlock members. The first member is made of a first material. The second member is made of a second material. The first material are less hard than the second material. The first member has a through thickness. The second member has a through thickness less than the through thickness of the first member. The mechanical interlock members of the array are mechanically embedded in the first member, and, when so embedded, the first and second members define a rigid body resistant to out-of-plane bending. The second member defines a skin of the assembly.

The embodiments include ones in which the first member has a length, a width, and a through thickness thereof; and the second member has a length, a width, and a through thickness. At least one of (a) the width of the second member are smaller than the width of the first member; and (b) the length of the second member are less than the width of the first member. In some embodiments the second member has a continuous web from which the mechanical interlock members stand outwardly into the first member, and the web of the second member defines a skin less than 1/10 of the through thickness of the first member. In some embodiments the second member has an exterior final finish. In some embodiments the second member defines a wear surface of the assembly. In some embodiments the first member is made of a material that is one of a polymer; aluminum, an aluminum alloy, copper, and mild steel; and the second member is made of aluminum, copper, bronze, brass, nickel, alloys or nickel, chromium, alloys of chromium, steel, stainless steel, and titanium. In those embodiments the assembly may includes a pairing that is one of: (a) the first member is a polymer, second member is any of the aforesaid metals; and (b) the first member is one of aluminum, aluminum alloy, copper, bronze and brass; second member is one of steel stainless steel, and titanium. The first member may be at least partially of hollow section. Where it is, the partially hollow section may be at least in part a closed periphery hollow section. The first member may be an extrusion. The second member may be roll-formed to conform to at least a portion of the first member. The first member may be an extrusion and the second member may be roll formed to the extrusion, the extrusion having a direction of extrusion, and the second member having a roll-forming direction that is parallel to the direction of extrusion. The assembly may be a foot support and the second member has an exposed surface defining a tread surface of the foot support. The assembly may be an exterior body panel of an automobile, and the second member defines a trim member of the assembly. The assembly of may define a portion of one of (a) a window frame; and (b) a door frame. When viewed along an axis of projection the first member may have a projected area; when viewed along the axis of projection the second member may have a smaller projected area than the first member; the second member is at least partially non-planar. The second member may be of non-cylindrical section. The second member may have a direction of embedment of the mechanical interlock members that is coincident with the axis of projection. The mechanical interlock members may be hooks. The first member may include an array of cells in which at least some cell walls are oriented to stand predominantly away from the second member. The cells of the array may be substantially hexagonal when viewed normal to the second member. The cells of the array may be substantially rectangular when viewed normal to the second member. The assembly may include a third member; the first member lying between the first member and the second member; the first member when mounted to the second member functioning as a first flange; the third member when mounted to the second member functioning as a second flange spaced away from the first flange. The third member may be made of a different material than the first member. The first member may be a metal and the third member may be a polymer. A fibrous member may be captured between the first member and the second member, and the mechanical interlock members of the array of the first member may reach or extend through the fibrous member to engage the second member. The fibrous member may include a woven fibrous member. The woven fibrous member may include strands of composite reinforcement fibers. The woven fibrous member may include strands of composite resin. The fibrous member may be uncured. The assembly may additionally include attachment between the first member and the second member by any of an adhesive, a bonding agent, a diffusion material, a eutectic bonding material and a compatabilizer.

In some embodiments there is a structural member having at least one of:
(a) a cylindrical member having an inner pipe wall, and an outer pipe wall; the inner and outer pipe walls are spaced from each other; an expanded filler matrix are located between the inner pipe wall and the outer pipe wall; at least one of the inner pipe wall and the outer pipe wall having a roughened surface mechanically interlocked to the filler matrix thereof; and
(b) an end cap member having an inner end cap wall, and an outer end cap wall; the inner and outer cap walls are spaced from each other; an expanded filler matrix are located between the inner end cap wall and the outer end cap wall; at least one of the inner end cap wall and the outer end cap wall having a roughened surface mechanically interlocked to the filler matrix thereof.

In those embodiments, the cylindrical member may have axially extending fluting and the filler matrix may include at least one hollow tube seated between members of the fluting. The structural member may include reinforced composite material located outwardly of the matrix filler material. These embodiments may include various features of the other embodiments noted above, in such combination as may be.

In some embodiments there is a mechanical interlock assembly. It has a first member and a second member. The first member has a web. The web has a first face having an array of mechanical interface members formed thereon of the material of the first member. The web has a self-holding non-planar form. The second member is a cloth member. The cloth member is engaged with the array of mechanical interface members of the first member. The first member thereby defines a non-planar shape-forming jig for the cloth member.

In those embodiments, the cloth member may have been cured, and the first and second members form a rigid, mechanically interlocked structural member. The assembly may include a third member, and the cloth member may be located between the first member and the third member. The mechanical interface members of the first member may reach or extend through the second member to engage the third member. The third member may be an open-celled web array. The first member may define a first flange of the assembly, the assembly may include a second flange distant from the first flange, and the second member may be located between the first and second flanges. The first member may be made of metal.

There is a method of manufacture of a non-planar assembly which may include obtaining a feedstock of web material, at least a portion of the web material defining a first member, the web material having at least one surface having an array of hooks formed therein from the web material itself; plastically deforming the first member to a self-sustaining non-planar condition; and engaging a second member to the array of hooks after the first member has been plastically deformed, whereby the second member takes on the non-planar condition of the first member.

The method of manufacture may include adding a third member, the second member being between the web member and the third member. The second member may be a cloth material and the method may include engaging the cloth material to the array of hooks whereby the cloth material conforms to the non-planar condition of the plastically deformed web material. The method may include mechanically interconnecting an expanded cell web to the first member. The first member may define an outer wall, and the method may include one of (a) having and (b) forming, an inner wall, the expanded cell web are located between the inner wall and the outer wall. The first member may be plastically deformed to have the shape of one of (a) an end cap; and (b) an outlet, of a flask. The method may include joining the first and second members to a cylindrical body portion of a flask. The method may include wrapping the flask in an external cloth of pre-impregnated composite reinforcement material. It may include weaving the cloth to have non-uniform properties. It may include curing the non-planar assembly so formed.

The description includes a method of manufacture of a non-planar assembly, the method including obtaining a feedstock of web material, at least a portion of the web material defining a first member, the web material having at least one surface having an array of hooks formed therein from the web material itself; engaging a second member to the array of hooks, the second member are a cloth member; and plastically deforming the first member to a self-sustaining non-planar condition, whereby the cloth member takes on the same non-planar condition as the first member.

The method may include curing the cloth member after engagement to the first member. The method may include use of any one of an adhesive, a bonding agent, a eutectic material, and a compatabilizer between the first member and the second member.

There is described a method of making a pipe, by forming a core defining a longitudinally extending conduit wall; positioning hollow cylindrical members about the conduit wall; mating a skin to the hollow cylindrical wall, the skin are made of a harder material than the hollow cylindrical members the skin having a roughened surface array of hooks formed of the material of the skin itself; and engaging the roughened surface array in at least partial embedment engagement with the hollow cylindrical members.

In that method, the core may have a set of external flutes, and the hollow cylindrical members seat between adjacent ones of the flutes. The hollow cylindrical members may be wound with a helical lay about the conduit wall. The hollow cylindrical members may define an outer layer of hollow cylindrical members; the method may include positioning an inner layer of hollow cylindrical members inside the outer layer of hollow cylindrical members arrayed about the core. The inner layer of hollow cylindrical members may be position with a different helical lay from the outer layer. The method may include use of any one of an adhesive, a bonding agent, a eutectic material, and a compatabilizer between the roughened surface and the hollow cylindrical members.

The methods may include any of the other steps noted above, in such combination as may be, and may employ the apparatus described above, in such features or combination of features as may be.

Several embodiments have been described hereinabove. Further embodiments can be made combining the features and aspects of those embodiments in such combinations and permutations as may be appropriate, as may be understood without need for redundant explanation of further description of all of those possible combinations and permutations.

What has been described above has been intended illustrative and non-limiting and it will be understood by persons skilled in the art that other variances and modifications may be made without departing from the scope of the disclosure as defined in the claims appended hereto. Various embodiments of the invention have been described in detail. Since changes in and or additions to the above-described best mode may be made without departing from the nature, spirit or scope of the invention, the invention is not to be limited to those details but only by the appended claims.

1. An assembly of materials comprising:
a first member;
a second member, said second member having an array of mechanical interlock members;
said first member being made of a first material;
said second member being made of a second material;
said first material being less hard than said second material;
said first member having a through thickness;
said second member having a through thickness less than said through thickness of said first member;
said mechanical interlock members of said array being mechanically embedded in said first member, and, when so embedded, said first and second members defining a substantially rigid body resistant to out-of-plane bending;
said second member defining a skin of said assembly.

2. The assembly of claim 1 wherein:
said first member has a length, a width, and said through thickness thereof; and said second member a length, a width, and said through thickness; and
at least one of (a) said width of said second member being smaller than said width of said first member; and (b) said length of said second member being less than said width of said first member.

3. (canceled)

4. The assembly of claim 1 wherein said second member has an exterior final finish.

5. The assembly of claim 1 wherein said second member defines a wear surface of said assembly.

6. The assembly of claim 1 wherein said first member is made of a material that is one of a polymer; aluminum, an aluminum alloy, copper, and mild steel; and said second member is made of aluminum, copper, bronze, brass, nickel, alloys or nickel, chromium, alloys of chromium, steel, stainless steel, and titanium.

7. (canceled)

8. The assembly of claim 1 wherein said first member is at least partially of hollow section.

9-13. (canceled)

14. The assembly of claim 1 wherein said assembly is an exterior body panel of an automobile, and said second member defines a trim member of said assembly.

15. (canceled)

16. The assembly of claim 1 wherein, when viewed along an axis of projection said first member has a projected area; when viewed along the axis of projection said second member has a smaller projected area than said first member; said second member is at least partially non-planar.

17-18. (canceled)

19. The assembly of claim 1 wherein said mechanical interlock members are hooks.

20. The assembly of claim 1 wherein said first member includes an array of cells in which at least some cell walls are oriented to stand predominantly away from said second member.

21-22. (canceled)

23. The assembly of claim 20 wherein said assembly includes a third member; said first member lies between said first member and said second member; said first member when mounted to said second member functions as a first flange; said third member when mounted to said second member functions as a second flange spaced away from said first flange.

24. The assembly of claim 23 wherein said third member is made of a different material than said first member.

25. The assembly of claim 24 wherein said first member is a metal and said third member is a polymer.

26. The assembly of claim 20 wherein a fibrous member is captured between said first member and said second member, and said mechanical interlock members of said array of said first member reach through said fibrous member to engage said second member.

27. The assembly of claim 26 wherein:
said fibrous member includes a woven fibrous member;
said woven fibrous member includes strands of composite reinforcement fibers; and
said woven fibrous member includes uncured strands of composite resin.

28-30. (canceled)

31. The assembly of claim 1 wherein said assembly additionally includes attachment between said first member and said second member by any of an adhesive, a bonding agent, a diffusion material, a eutectic bonding material and a compatabilizer.

32. A structural member comprising at least one of:
(a) a cylindrical member having an inner pipe wall, and an outer pipe wall; said inner and outer pipe walls being spaced from each other; an expanded filler matrix being located between said inner pipe wall and said outer pipe wall; at least one of said inner pipe wall and said outer pipe wall having a roughened surface mechanically interlocked to said filler matrix thereof; and
(b) an end cap member having an inner end cap wall, and an outer end cap wall; said inner and outer cap walls being spaced from each other; an expanded filler matrix being located between said inner end cap wall and said outer end cap wall; at least one of said inner end cap wall and said outer end cap wall having a roughened surface mechanically interlocked to said filler matrix thereof.

33-34. (canceled)

35. A mechanical interlock assembly comprising:
a first member and a second member
said first member having a web, said web having a first face having an array of mechanical interface members formed thereon of the material of said first member;
said web having a self-holding non-planar form;
said second member being a cloth member;
said cloth member being engaged with said array of mechanical interface members of said first member,
said first member thereby defining a non-planar shape-forming jig for said cloth member.

36. The mechanical interlock assembly of claim 35 wherein said cloth member has been cured, and said first and second members form a rigid, mechanically interlocked structural member.

37. The mechanical interlock assembly of claim 35 wherein said assembly includes a third member, and said cloth member is located between said first member and said third member.

38. The mechanical interlock assembly of claim 37 wherein said mechanical interface members of said first member reach through said second member to engage said third member.

39. The mechanical interlock assembly of claim 38 wherein said third member is an open-celled web array.

40. The mechanical interlock assembly of claim 35 wherein said first member defines a first flange of said assembly, said assembly includes a second flange distant from said first flange, and said second member is located between said first and second flanges.

41. The mechanical interlock assembly of claim 35 wherein said first member is made of metal.

42-60. (canceled)
